(19) United States
(12) Patent Application Publication
(10) Pub. No.: US 2011/0097024 A1
(43) Pub. Date: Apr. 28, 2011

(54) Easy Open Package with Discrete Panel Section with Die-Cut

(75) Inventors: Andrew W. Moehlenbrock, Simpsonville, SC (US); Joseph E. Owensby, Spartanburg, SC (US)

(73) Assignee: CRYOVAC, INC., Duncan, SC (US)

(21) Appl. No.: 12/889,530

(22) Filed: Sep. 24, 2010

Related U.S. Application Data
(60) Provisional application No. 61/279,529, filed on Oct. 22, 2009.

(51) Int. Cl. B65D 33/00; B31B 41/00

(52) U.S. Cl. 383/210; 493/210

(57) ABSTRACT

An easy-open package includes a pouch including a discrete panel section having a die cut, the panel section including an outer and inner surface, a first and second side edge, and a first and second end, at least a portion of the inner surface comprising a sealant, wherein the panel section and the second side panel are joined together along at least a portion of their respective first and second side edges with a seal, and the first end of the discrete panel section is joined to the second side panel, and a die cut is disposed in the discrete panel section; and the panel section is anchored to the first side panel; and a product disposed in the pouch.

This application claims the benefit of U.S. Provisional Application No. 61/279529, filed Oct. 22, 2009, that application incorporated herein by reference in its entirety.

### FIELD OF THE INVENTION

This invention relates to an easy-open package with a discrete panel section with a die-cut, and to methods of making the package.

### BACKGROUND OF THE INVENTION

Food and non-food products, including produce, snack foods, cheese, meat, and the like have long been packaged in containers such as pouches, bags, or lidded trays or formed webs made from various thermoplastic materials such as polyethylene, polypropylene, or polyester (PET). These containers can be formed from a web or webs of thermoplastic material on packaging equipment, using various packaging processes, at a processing/packaging facility. Such equipment and processes includes horizontal form/fill/seal (HFFS), vertical form/fill/seal (VFFS), thermoforming/lidstock, and continuous horizontal packaging (sometimes referred to as Flow-wrap). In each case, the product is manually or automatically placed in a pouch, bag, formed web, tray, etc., the filled container is optionally vacuumized or gas flushed, and the mouth of the container is hermetically or non-hermetically sealed to close and finish the package.

Opening of the finished package (i.e. opening with the use of tools such as scissors or knives) can provide access to the product by the consumer.

Common in the industry is the use of plastic zipper closures; press-to-close or slide zippers; interlocking closures; reclosable fasteners with interlockable fastener elements; interlocking rib and groove elements having male and female profiles; interlocking alternating hook-shaped closure members, and the like. These terms appear in the patent literature, and to some extent may overlap in meaning. These features in some cases may provide an easy-open feature to the package.

There is need in the marketplace for a package, and methods of packaging that can be used in a manner that requires little or no modification to the packager's packaging equipment, while providing a manually (i.e. by hand, without the need for tools such as scissors or knives) openable feature, optionally while maintaining hermeticity of the package when made, and without the use of plastic zipper closures; press-to-close or slide zippers; interlocking closures; reclosable fasteners with interlockable fastener elements; interlocking rib and groove elements having male and female profiles; interlocking alternating hook-shaped closure members, and the like.

Some retail packages currently do not offer an easy-open feature. Examples are some produce bags and snack food bags. In the produce market, there is a need for a cost-effective way to manually open retail produce bags, e.g. a package made in HFFS, VFFS, thermoforming/lidstock, or continuous horizontal packaging processes.

The present invention relates to a package, and methods of making the package, which package is manually openable, and adapted to package non-food products, as well as food products such as e.g. produce, snack foods, cheese, meat, luncheon meat, sausage, culinary nuts, trail mix, etc. The package optionally maintains a hermetic seal until the package is opened.

There is also a need in the marketplace for a discrete panel section that can be anchored to a processor's packaging material of choice to provide easy-open functionality to a package made from that web/panel section combination with only relatively minor modifications to the processor's packaging material, packaging process or equipment.

### SUMMARY OF THE INVENTION

### Statement of Invention/Embodiments of the Invention

In a first aspect, an easy-open package comprises:

a pouch comprising
a first and second side panel each comprising an outer and inner surface, a first and
second side edge, and a first and second end, the first and second side panels joined together along their respective first and second side edges with a seal;
a first end;
a second end defined by the second ends of the first and second side panels respectively; and
a discrete panel section comprising an outer and inner surface, a first and second side edge, and a first and second end, at least a portion of the inner surface comprising a sealant, wherein
   the discrete panel section and the second side panel are joined together along at least a portion of their respective first and second side edges with a seal,
   the first end of the discrete panel section is joined to the second side panel, and a die cut is disposed in the discrete panel section; and
      wherein the discrete panel section is anchored to the first side panel; and
a product disposed in the pouch.

Optionally, according to various embodiments of the first aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a second aspect, an easy-open package comprises a pouch comprising
a folded web comprising an exterior surface and an interior surface, and a first edge and a second edge,
a first transverse seal at a first end of the folded web,
a second transverse seal at a second end of the folded web,
a longitudinal seal extending along the length of the folded web; and
a discrete panel section comprising an outer and inner surface, a first and second side edge, and a first and second end, at least a portion of the inner surface comprising a sealant, and
a die cut disposed in the discrete panel section;
wherein the discrete panel section is anchored to the folded web; and
a product disposed in the pouch.

Optionally, according to various embodiments of the second aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the interior surface of the folded web.
a second part of the inner surface of the discrete panel section is anchored to the exterior surface of the folded web.
the first end of the discrete panel section, and the folded web, are joined together with a seal.
at least a portion of the inner surface of the discrete panel section comprises an easy-open sealant.
the first end of the discrete panel section, and the folded web, are joined together with an easy-open seal.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a third aspect, a method of making an easy-open package in a horizontal form/fill/seal process comprises
providing a lay-flat web comprising a first and second surface;
providing a discrete panel section comprising an outer and inner surface, a first and
second side edge, and a first and second end, at least a portion of the inner surface comprising a sealant, and a die cut disposed in the discrete panel section;
advancing the lay-flat web to a forming device to convert the lay-flat web to a folded web;
advancing the discrete panel section such that when the package is made, the discrete panel section is part of the package;
making side seals in the folded web and the discrete panel section;
cutting the folded web and the discrete panel section to produce an open pouch comprising
   a first and second side panel each comprising an outer and inner surface, a first and second side edge, and a first and second end, the first and second side panels joined together along their respective first and second side edges by a seal, the discrete panel section and second side panel joined along at least a portion of their respective first and second side edges by a seal, and the first end of the discrete panel section joined to the second side panel;
putting a product in the open pouch; and
sealing a first end of the pouch to close the pouch;
wherein, at any time before or during putting a product in the open pouch, the discrete panel section is anchored to the lay-flat web, the folded web, or the first side panel.

Optionally, according to various embodiments of the third aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a fourth aspect, a method of making an easy-open package in a horizontal form/fill/seal process comprises
providing a lay-flat web comprising a first and second surface;
   providing a discrete panel section comprising an outer and inner surface, a first and second side edge, and a first and second end, at least a portion of the inner surface comprising a sealant, and
   a die cut disposed in the discrete panel section;
wherein the discrete panel section is anchored to the lay-flat web; advancing the lay-flat web with the discrete panel section to a forming device to convert the lay-flat web to a folded web;
making side seals in the folded web and the discrete panel section;
cutting the folded web and the discrete panel section to produce an open pouch comprising a first and second side panel each comprising an outer and inner surface, first and second side edges, and a first and second end, the first and second side panels joined together along their respective first and second side edges by a seal, the discrete panel section and second side panel joined along at least a portion of heir respective first and second side edges by a seal, and the first end of the discrete panel section joined to the second side panel;
putting a product in the open pouch; and
sealing a first end of the pouch to close the pouch.

Optionally, according to various embodiments of the fourth aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a fifth aspect, a method of making an easy-open package in a vertical form/fill/seal process comprises
providing a lay-flat web comprising a first and second surface;
providing a discrete panel section comprising an outer and inner surface, a first and
second side edge, and a first and second end, at least a portion of the inner surface comprising a sealant, and
a die cut disposed in the discrete panel section;
advancing the lay-flat web over a forming device to convert the lay-flat web to a folded web;
advancing the discrete panel section such that when the package is made, the discrete panel section is part of the package;
making a longitudinal seal in the folded web and the discrete panel section;
transversely sealing the folded web and the discrete panel section to produce a first transverse seal to define a first pouch, wherein the first transverse seal is a bottom transverse seal of the first pouch;
putting a product in the first pouch;
advancing the folded web and the discrete panel section, with the first pouch, downward a predetermined distance;
transversely sealing the first pouch to produce a top transverse seal in the first pouch,
and a bottom transverse seal in a second pouch, the second pouch disposed above the first pouch; and
transversely cutting the folded web and the discrete panel section to separate the first pouch from the second pouch to make a package, the package comprising a first and
second side panel each comprising an outer and inner surface, first and second side edges, and a first and second end, the first and second side panels joined together along their respective first and second side edges, the discrete panel section and
second side panel joined along at least a portion of their respective first and second side edges, and the first end of the discrete panel section joined to the second side panel; the discrete panel section anchored to the first side panel;
wherein, at any time before or during the step of making the longitudinal seal, the discrete panel section is anchored to the lay-flat web or the folded web.

Optionally, according to various embodiments of the fifth aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a sixth aspect, a method of making an easy-open package in a vertical form/fill/seal process comprises
providing a lay-flat web comprising a first and second surface;
providing a discrete panel section comprising an outer and inner surface, a first and
second side edge, and a first and second end, at least a portion of the inner surface comprising a sealant, and
a die cut disposed in the discrete panel section;
the discrete panel sections anchored to the lay-flat web;
advancing the lay-flat web with the discrete panel section over a forming device to convert the lay-flat web to a folded web;
making a longitudinal seal in the folded web and the discrete panel section;
transversely sealing the folded web and the discrete panel section to produce a first transverse seal to define a first pouch, wherein the first transverse seal is a bottom transverse seal of the first pouch;
putting a product in the first pouch;
advancing the folded web and the discrete panel section, with the first pouch, downward a predetermined distance;
transversely sealing the first pouch to produce a top transverse seal in the first pouch, and a bottom transverse seal in a second pouch, the second pouch disposed above the first pouch; and
transversely cutting the folded web and discrete panel section to separate the first pouch from the second pouch to make a package, the package comprising a first and
second side panel each comprising an outer and inner surface, first and second side edges, and a first and second end, the first and second side panels joined together along their respective first and second side edges, the discrete panel section and second side panel joined along at least a portion of their respective first and second side edges, and the first end of the discrete panel section joined to the second side panel; the discrete panel section anchored to the first side panel.

Optionally, according to various embodiments of the sixth aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a seventh aspect, a method of making an easy-open package having a formed web comprises
providing a formed web having a first and second end, and a product cavity;
providing a product;
providing a lidstock, having a first and second end, comprising
   a lay-flat web comprising an outer and inner surface and a first and second edge, and
   a discrete panel section comprising an outer and inner surface, a first and second side edge, and a first and second end, at least a portion of the inner surface comprising a sealant, and
   a die cut disposed in the discrete panel section;
placing the product in the product cavity;
sealing the inner surface of the lidstock to the formed web; and
cutting the lidstock and formed web to make the package,
wherein, at any time before or during the step of sealing the inner surface of the lidstock to the formed web, the discrete panel section is anchored to the lay-flat web, and
wherein the first end of the discrete panel section is sealed to the formed web.

Optionally, according to various embodiments of the seventh aspect of the invention:
the discrete panel section is compositionally different from the lay-flat web.
a first portion of the die cut is a through-cut, and a second portion of the die cut is a score.
the outer surface of the discrete panel section comprises a sealant.
a second part of the outer surface of the discrete panel section is anchored to the inner surface of the lay-flat web.
a second part of the inner surface of the discrete panel section is anchored to the outer surface of the lay-flat web.
the first end of the discrete panel section, and the lay-flat web, are joined together with a seal.
at least a portion of the inner surface of the discrete panel section comprises an easy-open sealant.
the first end of the discrete panel section, and the lay-flat web, are joined together with an easy-open seal.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In an eighth aspect, a method of making an easy-open package having a formed web comprises
providing a formed web having a first and second end, and a product cavity;
providing a product;
providing a lidstock, having a first and second end, comprising
   a lay-flat web comprising an outer and inner surface, and a first and second edge,
   and
   a discrete panel section comprising an outer and inner surface, a first and second side edge, and a first and second end, at least a portion of the inner surface comprising a sealant, and
   a die cut disposed in the discrete panel section;
      wherein the discrete panel section is anchored to the lay-flat web;
   placing the product in the product cavity;
   sealing the lidstock to the inner surface of the formed web; and
   cutting the lidstock and formed web to make the package;
   wherein the first end of the discrete panel section is sealed to the formed web.

Optionally, according to various embodiments of the eighth aspect of the invention:
the discrete panel section is compositionally different from the lay-flat web.
a first portion of the die cut is a through-cut, and a second portion of the die cut is a score.
the outer surface of the discrete panel section comprises a sealant.
a second part of the outer surface of the discrete panel section is anchored to the inner surface of the lay-flat web.
a second part of the inner surface of the discrete panel section is anchored to the outer surface of the lay-flat web.
the first end of the discrete panel section, and the lay-flat web, are joined together with a seal.
at least a portion of the inner surface of the discrete panel section comprises an easy-open sealant.
the first end of the discrete panel section, and the lay-flat web, are joined together with an easy-open seal.
the die cut is a closed loop.
the package is absent any zipper.
the package is absent a base strip attached to the discrete panel section.
the package is absent a repositionable adhesive between the base strip and the discrete panel section.
the package can be opened with a peel force of from 25 grams/inch to 5 pounds/inch.

In a ninth aspect, a method of making an easy-open package in a continuous horizontal packaging process comprises

providing a lay-flat web comprising a first and second surface;
providing a discrete panel section comprising an outer and inner surface, a first and second side edge, and a first and second end, at least a portion of the inner surface comprising a sealant, and
a die cut disposed in the discrete panel section;

advancing the lay-flat web to a forming device to convert the lay-flat web to a folded web having an inner surface;

advancing the discrete panel section such that when the package is made, the discrete panel section is part of the package;

advancing a product to the forming device such that the folded web and the discrete panel section envelope the product;
making a longitudinal seal in the folded web and the discrete panel section;
transversely sealing the folded web and the discrete panel section, with the product therein, to produce a leading transverse seal to define a first pouch;
advancing the folded web and the discrete panel section, with the leading transverse seal, forward a predetermined distance;

transversely sealing the first pouch to produce a trailing transverse seal in the first pouch, and a leading transverse seal in a second pouch, the second pouch disposed upstream of the first pouch; and

transversely cutting the folded web and the discrete panel section to separate the first pouch from the second pouch to make a package, the package comprising a first and second side panel each comprising an outer and inner surface, first and second side edges, and a first and second end, the first and second side panels joined together along their respective first and second side edges, the discrete panel section and second side panel joined along at least a portion of their respective first and second side edges, and the first end of the discrete panel section joined to the second side panel; the discrete panel section anchored to the first side panel;

wherein, at any time before or during the step of making the longitudinal seal, the discrete panel section is anchored to the lay-flat web or the folded web.

Optionally, according to various embodiments of the ninth aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In a tenth aspect, a method of making an easy-open package in a continuous horizontal packaging process comprises
providing a lay-flat web comprising a first and second surface;
providing a discrete panel section comprising an outer and inner surface, a first and second side edge, and a first and second end, at least a portion of the inner surface comprising a sealant, and
a die cut disposed in the discrete panel section;
wherein the discrete panel section is anchored to the lay-flat web;

advancing the lay-flat web with the discrete panel section to a forming device to convert the lay-flat web to a folded web having an inner surface;

advancing a product to the forming device such that the folded web and the discrete panel section envelope the product;

making a longitudinal seal in the folded web and the discrete panel section;
transversely sealing the folded web and the discrete panel section, with the product therein, to produce a leading transverse seal to define a first pouch;
advancing the folded web and the discrete panel section, with the leading transverse seal, forward a predetermined distance;
transversely sealing the first pouch to produce a trailing transverse seal in the first pouch, and a leading transverse seal in a second pouch, the second pouch disposed upstream of the first pouch; and
transversely cutting the folded web and the discrete panel section to separate the first pouch from the second pouch to make a package, the package comprising a first and
second side panel each comprising an outer and inner surface, first and second side edges, and a first and second end, the first and second side panels joined together along their respective first and second side edges, the discrete panel section and
second side panel joined along at least a portion of their respective first and second side edges, and the first end of the discrete panel section joined to the second side panel; the discrete panel section anchored to the first side panel.

Optionally, according to various embodiments of the tenth aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the package is absent any zipper.
the package is absent a base strip attached to the discrete panel section.
the package is absent a repositionable adhesive between a base strip and the discrete panel section.
the package can be opened with a peel force of from 25 grams/inch to 5 pounds/inch.

In an eleventh aspect, a pouch comprises
a first and second side panel each comprising an outer and inner surface, a first and
second side edge, and a first and second end, the first and second side panels joined together along their respective first and second side edges with a seal;
a first end;
a second end defined by the second ends of the first and second side panels respectively; and
a discrete panel section comprising an outer and inner surface, a first and second side edge, and a first and second end, at least a portion of the inner surface comprising a sealant, wherein
   the discrete panel section and the second side panel are joined together along at least a portion of their respective first and second side edges with a seal; and
   the first end of the discrete panel section is joined to the second side panel; and
   a die cut disposed in the discrete panel section; and
the discrete panel section is anchored to the first side panel.

Optionally, according to various embodiments of the eleventh aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the second end of the first side panel, and the second end of the second side panel, are joined together with a seal.
the second end of the first side panel, and the second end of the second side panel, are joined together with a fold.
the die cut is a closed loop.
the pouch, and a package made from the pouch, is absent any zipper.
the pouch, and a package made from the pouch, is absent a base strip attached to the discrete panel section.
the pouch, and a package made from the pouch, is absent a repositionable adhesive between a base strip and the discrete panel section.
a package made from the pouch can be opened with a peel force of from 25 grams/inch to 5 pounds/inch.

In a twelfth aspect, a method of making a bag with a discrete panel section disposed thereon comprises
extruding a thermoplastic tube to make a bag tubing;
   providing a discrete panel section comprising an outer and inner surface, a first and second side edge, and a first and second end, at least a portion of the inner surface comprising a sealant, and
   a die cut disposed in the discrete panel section,
slitting the tubing at a longitudinal edge thereof to make a slit bag tubing; anchoring the discrete panel section to the slit bag tubing; and
transversely cutting and sealing the slit bag tubing at predetermined intervals to make a plurality of individual bags each with the discrete panel section disposed thereon, each bag comprising a first and second side panel each comprising an outer and inner surface, first and second side edges, and a first and second end, the first and second side panels joined together along their respective first and
second side edges by a seal, a first end defined by the first ends of the first and second side panels respectively, an end fold defined by the second ends of the first and second side panels respectively, and the first end of the discrete panel section joined to the second side panel;
wherein at any time before or during the step of slitting the bag tubing, the discrete panel section is anchored to the first side panel.

Optionally, according to various embodiments of the twelfth aspect of the invention:
the discrete panel section is compositionally different from the first side panel.
a first portion of the die cut is a through-cut, and a second portion of the die cut is a score.
the outer surface of the discrete panel section comprises a sealant.
a second part of the outer surface of the discrete panel section is anchored to the inner surface of the first side panel.
a second part of the inner surface of the discrete panel section is anchored to the outer surface of the first side panel.
the first end of the discrete panel section, and the first end of the second side panel, are joined together with a seal.
at least a portion of the inner surface of the discrete panel section comprises an easy-open sealant.
the first end of the discrete panel section, and the first end of the second side panel, are joined together with an easy-open seal.
the die cut is a closed loop.
the bag, and a package made from the bag, is absent any zipper.
the bag, and a package made from the bag, is absent a base strip attached to the discrete panel section.
the bag, and a package made from the bag, is absent a repositionable adhesive between a base strip and the discrete panel section.
a package made from the bag can be opened with a peel force of from 25 grams/inch to 5 pounds/inch.

### BRIEF DESCRIPTION OF THE DRAWINGS

The present invention is illustrated by reference to the following drawing figures, encompassing different views of various embodiments of the invention, wherein:

FIG. 1 is an elevational view of a package;

FIG. 2 is an enlarged view of a portion of the package of FIG. 1;

FIG. 2A is an enlarged cross-sectional view of a portion of FIG. 1;

FIG. 3 is an enlarged cross-sectional view of another embodiment of a portion of FIG. 1;

FIG. 4 is a front view of the package of FIG. 1, viewed along lines 4-4 of FIG. 1;

FIG. 5 is a back view of the package of FIG. 1, viewed along lines 5-5 of FIG. 1;

FIG. 6 is a cross-sectional view of a discrete panel section;

FIG. 7 is a cross-sectional view of a discrete panel section according to another embodiment;

FIG. 8 is a perspective view of a HFFS process and apparatus for making a package;

FIG. 9A is a perspective view of a HFFS process and apparatus for making a package according to another embodiment;

FIG. 9B is a perspective view of a section of folded web;

FIG. 9C is a perspective view of a section of a gusseted folded web;

FIG. 10 is an elevational view of a VFFS process and apparatus for making a package;

FIG. 11 an elevational view of a VFFS process and apparatus for making a package according to another embodiment;

FIG. 12 is a perspective view of a roll of lay-flat web and a roll of a discrete panel section;

FIG. 13 is a perspective view of a roll of lay-flat web and a discrete panel section according to another embodiment;

FIG. 14 is an elevational view of two consecutive pouches in a VFFS embodiment;

FIG. 15 is a perspective view of a folded web for use in the invention;

FIG. 16 is a perspective view of a folded web for use in the invention;

FIG. 17 is a side view of a tray for use in connection with the invention.

FIG. 18 is a perspective view of a package;

FIG. 19 is a perspective view of the package of FIG. 18 in an opened condition;

FIG. 20 is a plan view of a lidstock;

FIG. 21 is a plan view of a lidstock according to another embodiment;

FIG. 22 is an elevational view of a continuous horizontal packaging process and apparatus for making a package;

FIG. 23 is a front end view of the apparatus of FIG. 22, viewed along lines 23-23 of FIG. 22;

FIGS. 24A, 24B, and 24C are each cross-sectional views of a portion of the package, showing a sequence for opening the package;

FIGS. 25A and 25B are each plan views of the package, showing a sequence for opening the package;

FIG. 25C is a plan view showing an alternative method of opening a package;

FIG. 25D is an enlarged view of a portion of the package of FIG. 25C;

FIGS. 26A, 26B, 26C, 26D, 26E, and 26F are each a plan view of alternative embodiments;

FIG. 27 is a cross sectional view of an alternative embodiment;

FIG. 28 is a plan view of another embodiment of the invention;

FIG. 29 is a cross sectional view of FIG. 28, viewed along lines 29-29 of FIG. 28;

FIG. 30 is a cross sectional view of an alternative embodiment;

FIG. 31 is a cross sectional view of an alternative embodiment;

FIG. 32 is a cross sectional view of an alternative embodiment; and

FIG. 33 is a cross sectional view of an alternative embodiment.

### DEFINITIONS

“Anchored”, “anchoring” and the like herein refers to sealing or adhering two surfaces together, and refers to the resulting bond between surfaces. Sealing is done by means of a sealant. Adhering is done by means of an adhesive.

In processes described herein where a discrete panel section is anchored to a web or side panel, either during the process wherein the web and discrete panel section are advanced, or when a discrete panel section has been pre-anchored to the web before the start of the process, anchoring can be done by use of any suitable continuous or discontinous sealing or adhesive material and method. Such anchoring is done to hold the discrete panel section to the web or panel during the relevant packaging process.

In some embodiments, wherein the anchor is already relatively strong or continuous, e.g. a heat seal that constitutes either a relatively strong heat seal, or an easy-open seal as defined herein, the anchor functions not only to hold the discrete panel section to the web or panel during the relevant packaging process, but also as a final seal of that surface of the discrete panel section to the web (lay-flat or folded) or panel made from the web.

Any subsequent disclosed or recited step in the process of sealing one of the surfaces (i.e. the anchored surface) of the discrete panel section to a web or panel, is already completed by the anchoring step. In these embodiments, then, contact of a seal device, e.g. a seal bar in the region of the anchor, in a subsequent step, may in some embodiments add no further or separate seal to that surface of the discrete panel section.

Any subsequent step in the process of sealing the other surface of the discrete panel section to a web or panel, then, may in some embodiments add no further or separate seal to the anchored surface of the discrete panel section.

In some embodiments where the bond is a relatively weak or discontinuous one, e.g. a discontinuous seal, spots or narrow stripes of adhesive. etc., in a subsequent step of sealing one of the surfaces of the discrete panel section to the web or panel, a seal bar that seals one of the surfaces of the discrete panel section to the web or panel can contact the web or panel in the region where the anchor is already disposed. The seal in that region may be either enhanced, or initially created, by the subsequent sealing step.

Sealing of a surface of the discrete panel section to a web or panel, as a process step disclosed or recited herein, should be understood in this light.

“Close-looped” herein refers to a die cut that defines a closed pattern or path in the discrete panel section whereby the web material within the path (the die-cut segment) can be removed from the panel.

“Die cut” herein refers to methods of cutting or scoring materials, including rotary die, steel rule die, platen die cutting, and laser cutting or scoring, and/or the resultant cut or score. A die cut can extend entirely through the relevant layer or web (defining a throughcut) or can extend partially through the relevant layer or web (defining a score), thus leaving intact a certain amount of material. A given die cut can in one embodiment be a combination of a through-cut and a score. The depth of the cut can vary from package to package, and within a single die cut on a given package.

“Die-cut segment” herein refers to a portion of the discrete panel section that can be displaced or completely removed because of the presence of a closed loop or open loop die cut. The die-cut segment is a piece of the discrete panel section, and when displaced or removed can sometimes function as a tamper evidence device, and facilitates access to the interior of the package.

“Discrete” with respect to the discrete panel section is used herein to mean independently made (the discrete panel section is not an integral part of the web when the web is made,) or constituting a separate entity from the web, and from a first or second side panel made from the web.

“Easy-open” herein refers to a package that can be manually opened relatively easily. The physical mode of opening may include a) actual peeling at the discrete panel section/web interface (adhesive failure), or b) a sealant layer of the discrete panel section breaking completely through, and peeling then occurring between the sealant layer and an adjacent layer within the panel section (delamination failure), or c) breaking within a sealant layer by rupturing of the sealant material itself (cohesive failure). The peel force required to open the package can be measured by an evaluation of seal strength or peel strength in accordance with the test procedure set out in ASTM F88, incorporated herein by reference in its entirety, using a crosshead speed of 8 to 12 inches/minute and an initial jaw gap of from 1.00 inch to 2.00 inch. Typical peel forces for opening the package of the invention can range from e.g. 25 grams/inch to 3 pounds/inch, e.g. from 100 grams/inch to 2 pounds/inch, such as from 200 grams/inch to 1.5 pounds/inch. In some cases, the sealant may actually peel away from the surface to which it is adhered (adhesive failure), or breakage of the sealant and delamination along an adjacent layer interface may occur (delamination failure) or a rupture of the sealant can occur (cohesive failure). Depending on the design and geometry of the seal, peel forces can in some embodiments be higher than 3 pounds/inch, e.g. 3.5, 4.0, 4.5, or 5 pounds/inch, or values intermediate these values.

“Easy-open seal” herein refers to a seal involving the discrete panel section and web in which materials and sealing conditions are chosen for the discrete panel section and web such that the package is easy-open with a physical mode of opening of adhesive failure, delamination failure, or cohesive failure as described herein. An easy-open sealant can be used to provide the easy-open seal. Where the easy-open sealant is a removable adhesive, the easy-open seal mechanism is a form of “adhesive failure” discussed further below.

“Easy-open sealant” herein refers to a material chosen for one or both surfaces of the discrete panel section and/or web, such that when such surface is sealed to another surface, e.g. the surface of a web or discrete panel section, it provides a package that is easy-open with a physical mode of opening of adhesive failure, delamination failure, or cohesive failure as described herein. The material can be a polymer or polymer blend that e.g. is extruded as an external layer of a web or discrete panel section. Alternatively, the material can be a removable adhesive, such as certain PSA materials, that is coated on at least a portion of a surface of a web or discrete panel section.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. EAO includes heterogeneous materials such as linear medium density polyethylene (LMDPE), linear low density polyethylene (LLDPE), and very low and ultra low density polyethylene (VLDPE and ULDPE); single-site catalyzed materials such as homogeneous linear ethylene/alpha olefin copolymers and long chain branched ethylene/alpha olefin copolymers; and multicomponent ethylene/alpha-olefin interpenetrating network resin (or “IPN resin”).

“Ethylene homopolymer or copolymer” herein refers to polyethylene (PE) such as ethylene homopolymer such as low density polyethylene (LDPE), medium density polyethylene (MDPE), high density polyethylene (HDPE); ethylene/alpha olefin copolymer such as those defined herein; ethylene/vinyl acetate copolymer (EVA); ethylene/alkyl acrylate copolymer such as ethylene/methyl acrylate copolymer (EMA) or ethylene/ethyl acrylate copolymer (EEA), or ethylene/butyl acrylate copolymer (EBA); ethylene/(meth)acrylic acid copolymer; or ionomer resin (IO).

“Fig.” and the like herein refers to a drawing figure; “Figs.” and the like herein to drawing figures.

“Film” is used herein to mean a thermoplastic film, laminate, or web, either multilayer or monolayer, that may be used in connection with the present invention. Film can be of any suitable thickness, e.g. between 0.1 and 30 mils.

“Fin seal” is used herein to mean, in the case of a single web, folding one edge of the web towards the opposite edge of the web, and sealing the facing inner surfaces together. In the case of two webs, a fin seal is a seal formed by sealing the inner surface of the edge of one web to the inner surface of a corresponding edge of another web.

“Lap seal” is used herein to mean a seal made by sealing an inside surface of a web to an outside surface of a web. The inside and outside surfaces can both be on a single web; or the inside surface can be of one web, and the outside surface of a second web.

“Lidstock” herein refers to a film used to cover a container or tray that carries a product, and can be sealed to the tray, typically as a perimeter heat seal. Lidstock typically is supplied to a food processor in a lay flat film rolled onto a roll.

“Longitudinal seal” herein refers to a fin seal or lap seal.

“Near” herein means, with respect to the position of the discrete panel section in relation to the package, that the edge of the discrete panel section closest to the first end of the pouch and package will be typically within about three inches of the first end of the pouch. The discrete panel section can be closer than this, such as within about two inches, one inch, 0.75 inches, 0.5, 0.4, 0.3, 0.2, or 0.1 inches of the first end of the pouch.

“Olefinic” and the like herein refers to a polymer or copolymer derived at least in part from an olefinic monomer.

“Oxygen barrier” and the like herein refers to materials having an oxygen permeability, of the barrier material, less than 500 cm³ O₂ /m²·day·atmosphere (tested at 1 mil thick and at 25° C., 0% RH according to ASTM D3985), such as less than 100, less than 50, less than 25, less than 10, less than 5, and less than 1 cm³ O₂/m²·day atmosphere. Examples of polymeric materials useful as oxygen barrier materials are ethylene/vinyl alcohol copolymer (EVOH), polyvinylidene dichloride (PVDC), vinylidene chloride/methyl acrylate copolymer, vinylidene chloride/vinyl chloride copolymer, polyamide (nylon), and polyester (PET).

“Pouch” herein means a pouch or bag.

“Polymer” and the like herein means a homopolymer, but also a copolymer thereof, including terpolymer, tetrapolymer, block copolymer, etc.

“Repositionable adhesive” as used herein refers to an adhesive, such as certain pressure sensitive adhesives (PSA) that bond firmly with the application of light pressure; can be easily removed; and can be repositioned and reused multiple times, i.e. it can be adhered to a surface, removed, and reapplied to a surface with substantial adhesive capability. It adheres to most surfaces with very slight pressure; is available in solvent, latex or water based forms, and hot melt forms, and is often based on non-crosslinked rubber adhesives, acrylics, or polyurethanes. PSA forms viscoelastic bonds that are aggressively and permanently tacky; adhere without the need for more than hand pressure; and require no activation by water, solvent, or heat. Some PSA materials are cured by hot air, electron beam, UV, or chemical (peroxide) means. They are available in a wide variety of chemical compositions and systems including acrylic and methacrylate adhesives, emulsion-based acrylic adhesive; rubber-based pressure sensitive adhesive, styrene copolymers (styrene/isoprene/styrene and styrene/butadiene/styrene block copolymers), and silicones. PSA herein can include hot melt adhesives. A hot melt adhesive is a thermoplastic adhesive compound, usually solid or highly viscous at room temperature which becomes more fluid on heating for application. Repositionable adhesive as used herein is not a removable adhesive as used herein.

“Registration device” herein refers to any mark, pattern, die cut or feature of a web or discrete panel section, that facilitates the advancement of the web or discrete panel section, or a component thereof, in a controlled manner, into a packaging machine, where the web and/or discrete panel section is used to make individual packages. The device can be e.g. printed or placed in uniformly spaced fashion along or near an edge of the web or discrete panel section, i.e. registration marks, or in an area near the middle of a web that does not interfere with decorative printed graphics. These marks are used in connection with appropriate sensors to controllably advance the web or discrete panel section. Where die cuts are used as a registration device, detected by sensors, it may not be necessary to print registration marks on the web or discrete panel section.

“Removable adhesive” herein refers to an adhesive which exhibits a low initial peel strength to allow for easy removal of the web or discrete panel section after it has been stuck to the desired surface, with no substantial residual adhesive capability once it has been removed. Removable adhesive can be used to make an easy-open seal as disclosed herein. A surface comprising a removable adhesive can comprise at least a portion of that surface with a removable adhesive thereon wherein another portion of that surface optionally does not comprises a removable adhesive.

Removable adhesive as used herein is not a repositionable adhesive.

“Seal” herein means a bond between two thermoplastic surfaces, e.g. as produced by heat sealing, radio frequency (RF) sealing, ultrasonic sealing, or permanent adhesive.

“Sealant” is a polymeric material or blend of materials, such as olefinic polymer or copolymer such as an ethylenic polymer or copolymer, that can form a surface of the discrete panel section of the invention, or a web to which the discrete panel section is sealed, and form a bond between two thermoplastic surfaces. An easy-open sealant, permanent or removable adhesive can also be a sealant. “Sealant” herein, with respect to the discrete panel section, or a web to which the discrete panel section is adhered, excludes a repositionable adhesive. A surface comprising a sealant can comprise in one embodiment at least a portion of that surface with a sealant therein or thereon (polymer or permanent adhesive) wherein another portion of that surface optionally does not comprise a sealant.

“Discrete panel section” herein refers to a piece of thermoplastic material, typically longer in a first direction than in a direction perpendicular to the first direction, e.g. rectangular; but can also be square, round, oblong, elliptical, or any appropriate shape in plan view. The discrete panel section can be of any suitable thickness, e.g. between 0.1 and 30 mils.

“Tamper evidence”, “tampering”, and the like herein refers to visual evidence of a breach in a package; i.e. that someone has accidentally or intentionally opened or partially opened the package, or attempted to do so.

“Thermoplastic” herein includes plastic materials that when heated to a softening or melting point may be reshaped without significant thermal degradation (burning). Thermoplastic includes both materials that are not crosslinked, or that are crosslinked by chemical or radiation means.

“Tray” herein refers to a formed member that has a tray bottom, tray sides, and a tray flange around the upper perimeter of the tray, where the tray bottom and tray sides form an internal cavity within which a product can be placed. The cavity can be enclosed by a lidstock sealed to the tray flange.

“Web” is used herein to mean a thermoplastic film, laminate, or web, either multilayer or monolayer, that may be used in connection with the present invention. The web can be of any suitable thickness, e.g. between 0.1 and 30 mils, and the web can be of any suitable length and width.

“Zipper” and the like herein refers to a plastic zipper closure; press-to-close or slide zipper; interlocking closure; reclosable fastener with interlockable fastener elements; interlocking rib and groove elements having male and female profiles; interlocking alternating hook-shaped closure, and the like.

All compositional percentages used herein are presented on a “by weight” basis, unless designated otherwise.

Drawings herein are not necessarily to scale, and certain features of the invention may be graphically exaggerated for clarity.

### DETAILED DESCRIPTION OF THE INVENTION

1. Package

Referring to the drawings, a package 5 according to the invention is shown. Package 5 includes a pouch 7 that can be made from either a single web, or two webs, to form a first side panel 12, and a second side panel 14.

A. Web(s)

In either embodiment, the web or webs comprises a thermoplastic material of any suitable composition, including those having as at least one component olefinic materials such as ethylene or propylene polymers or copolymers, e.g. polyethylene or ethylene/alpha olefin copolymers; polyethylene terephthalate (PET); and including webs typically used in, or useful in, HFFS, VFFS, lidstock/tray, continuous horizontal packaging, and bag making apparatus and processes. The web or webs can be monolayer or multilayer in construction, can be coextruded, laminated, or made by any suitable film making process, and can have any suitable thickness.

Examples of web(s) that can be used with a discrete panel section of the invention include H7225B™, a barrier hybrid material used for products requiring a high oxygen barrier, such as shredded cheese; H7525B™, a barrier hybrid material used for products requiring a high oxygen barrier, such as bacon and smoked and processed meat; CP04140™, a low barrier (high OTR) material used in produce packaging, CPM4090, a microwaveable packaging film for fresh cut produce; and T7225B™, a barrier material used as lidstock (non-forming web) for products requiring a high oxygen barrier, such as luncheon meat. These are all commercial products produced by the Cryovac business unit of Sealed Air Corporation.

H7225B™ is a laminate having the construction PET//adhesive//coextruded barrier film, where the PET is a biaxially oriented polyester film, and the barrier film has the construction LDPE (low density polyethylene)/EVA tie/nylon/EVOH+nylon/nylon/EVA tie/EAO. The overall thickness of the laminate can be any of several gauges, being typically about 2.5 mils. The LDPE is the surface of the barrier film adhered, by the adhesive, to the PET film. The EAO typically acts as the heat sealant layer of the film, and finished laminate, and in packaging made from the laminate, the EAO will form the inner or sealant surface of the package, facing the contained product, and the PET will form the outer or skin surface of the package. H7225B™ can be used as a lidstock (non-forming) web.

H7525B™ is a laminate having the construction PET//adhesive//coextruded barrier film, where the PET is a biaxially oriented polyester film, and the barrier film has in one embodiment the construction LDPE (low density polyethylene)/EVA/LLDPE tie/EVOH/LLDPE tie/EVA/EAO. The overall thickness of the laminate can be any of several gauges, being typically about 2.5 mils. The LDPE is the surface of the barrier film adhered, by the adhesive, to the PET film. The EAO typically acts as the heat sealant layer of the film, and finished laminate, and in packaging made from the laminate, the EAO will form the inner or sealant surface of the package, facing the contained product, and the PET will form the outer or skin CP04140™ is a laminate having the construction BOPP//adhesive/monolayer LLDPE film. A typical gauge for the laminate is about 1.8 mils. The LLDPE typically acts as the heat sealant layer of the finished laminate, and in packaging made from the laminate, the LLDPE will form the inner or sealant surface of the package, facing the contained product, and the BOPP will form the outer or skin surface of the package.

CPM4090™ is a laminate having the construction BOPP//adhesive/monolayer LLDPE+LDPE film. A typical gauge for the laminate is about 2 mils. The LLDPE+LDPE layer typically acts as the heat sealant layer of the finished laminate, and in packaging made from the laminate, the LLDPE+LDPE will form the inner or sealant surface of the package, facing the contained product, and the BOPP will form the outer or skin surface of the package.

T7225B™ film has the construction EAO/EAO/LLDPE tie/nylon/EVOH/nylon/EVA tie/EVA tie/nylon. The first layer of EAO typically acts as the heat sealant layer of the film, and in packaging made from the laminate, the EAO will form the inner or sealant surface of the package, facing the contained product, and the nylon of the last layer will form the outer or skin surface of the package.

Referring to the drawings, the first side panel 12 has a top portion 9, a first side edge 31, a second side edge 33, and a lower portion 17. The second side panel 14 has a top portion 11, a first side edge 35, a second side edge 37, and a lower portion 18. The first and second side panels 12 and 14 are joined together along their respective first and second side edges by either a seal or a fold. As shown, first side edge 31 of first side panel 12 is joined to first side edge 35 of second side panel 14 by a seal 30. Second side edge 33 of first side panel 12 is joined to second side edge 37 of second side panel 14 by a heat seal 32. The second end 34 of the pouch 7 can be either a seal or a fold. Where a single web is used to make the pouch, second end 34 will typically be a fold, although even after the web is folded, a seal such as a heat seal can optionally be installed in the area of the fold. Where two webs of film are used to make panels 12 and 14, second end 34 will be a seal that joins panels 12 and 14 together along their respective lower portions 17 and 18. The two webs can be from the same material, or can be different in composition, structure, etc.

B. Discrete Panel Section

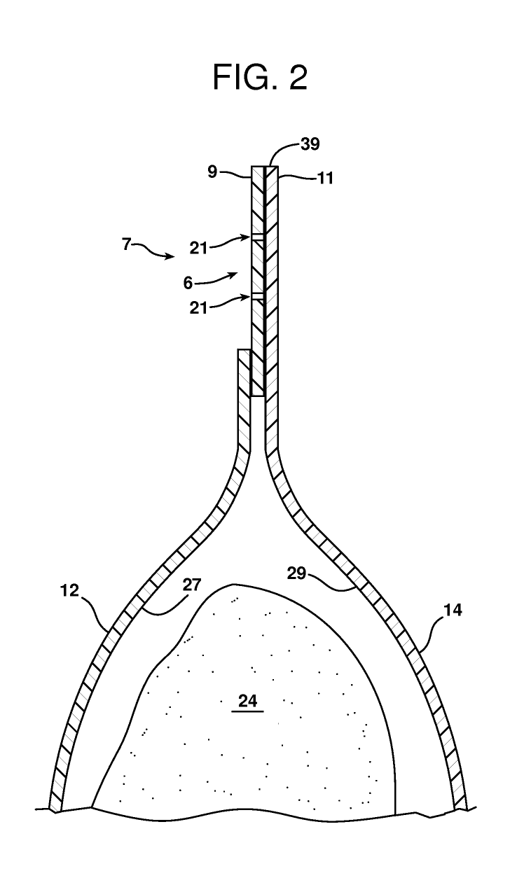

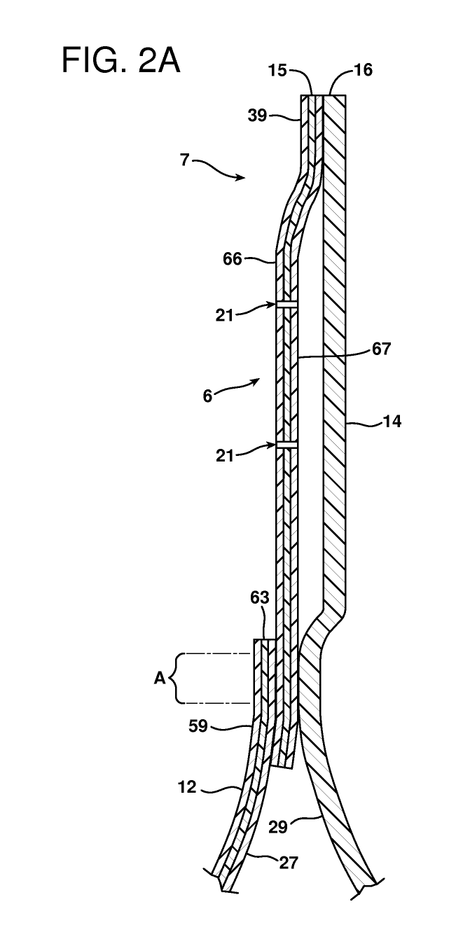

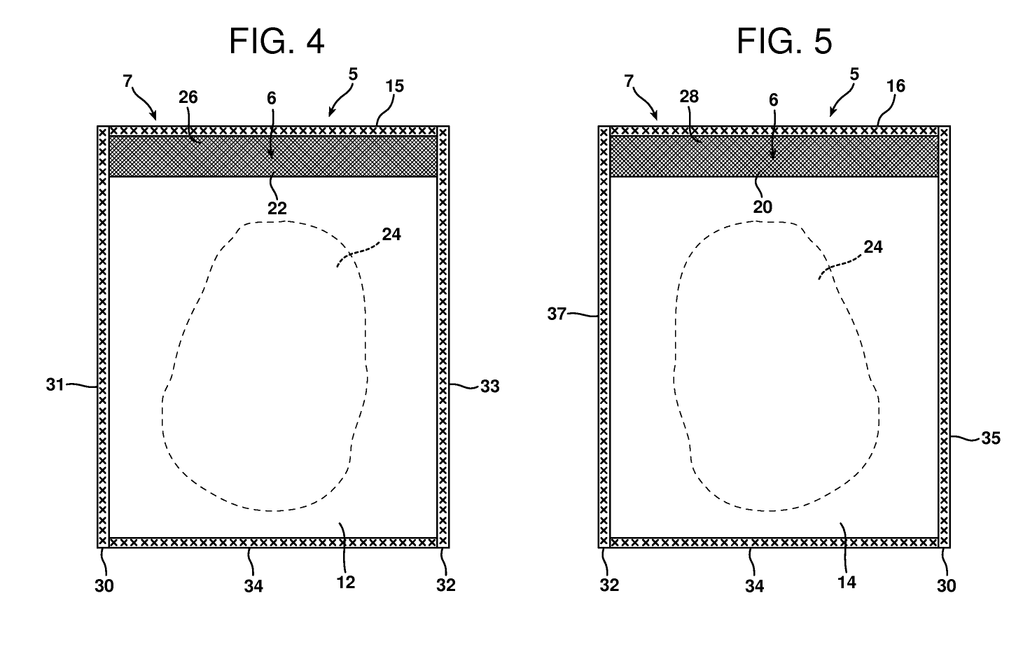

A discrete panel section 6 (see e.g. FIG. 2A) has an outer surface 66 and inner surface 67. The discrete panel section can be of any suitable dimension and shape, and will typically be longer in length than in width, with the length being e.g. greater than two times the width, e.g. greater than 3, 4, or 5 times the width. A typical dimension for the discrete panel section is a width of from about 1 to 1.5 inches and a length of about 4 to 10 inches. The panel section 6 will be shorter in one dimension than the pouch and package. For example, the panel section can extend across the transverse width of a pouch made in e.g. a HFFS or VFFS process, but will be shorter than the length of the package (see e.g. FIGS. 4 and 5). In one embodiment, the panel section will occupy less than 50%, such as less than 40%, less than 30%, less than 20%, or less than 10% of the length of the package.

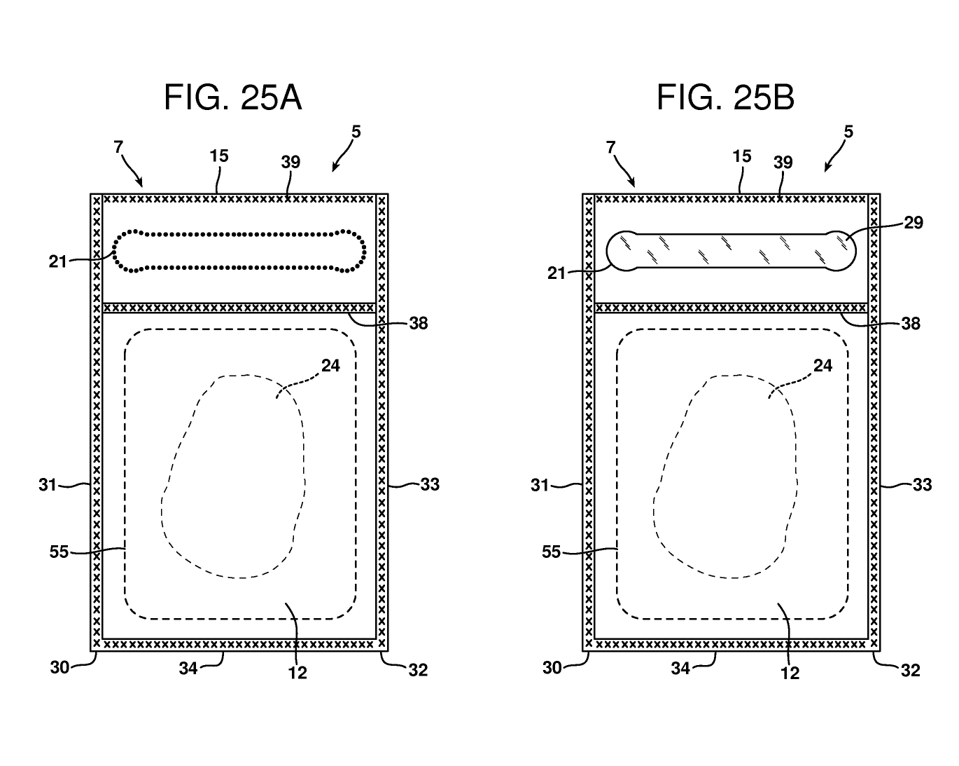

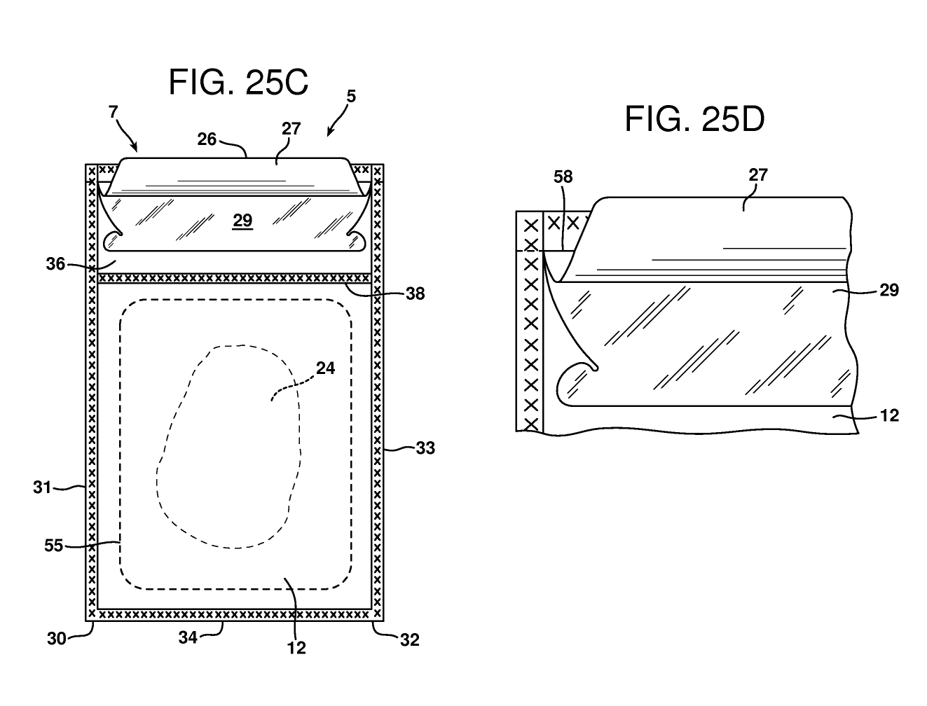

In some embodiments, an opening flap 26 or 626 (e.g. FIGS. 19, 25C and 25D) provides a device that can be manually grasped and pulled back to open the package, and access the contents of the package. The size of the package, type of materials used for the pouch and the discrete panel section, the seal strength of the materials used in the panel section, and the type of product being packaged can all have some effect on the choice of the optimal length and dimensions of flap 26 or 626.

Discrete panel section 6 comprises an outer surface 66 and an inner surface 67. At least a portion of second surface 67 comprises an easy open sealant. Outer surface 66 in some embodiments comprises a sealant. Panel section 6 is anchored to first side panel 12. The inner surface 67 is sealed to the inner surface 29 of the second side panel 14 with an easy-open seal.

The panel section 6 can be of multilayer or monolayer construction.

When a product 24 is placed in the pouch 7, by any suitable process such as processes herein disclosed, and the pouch 7 is closed, the package 5 is made.

Any suitable materials, including those disclosed herein for web or webs for making the first and side panels, e.g. a thermoplastic material of any suitable composition, monolayer or multilayer in construction, coextruded, laminated, or made by any suitable film making process, and of any suitable thickness, including hybrid materials of the type described herein for web materials, e.g. H7225B or a non-barrier analog of such material, can be used to make the discrete panel section 6.

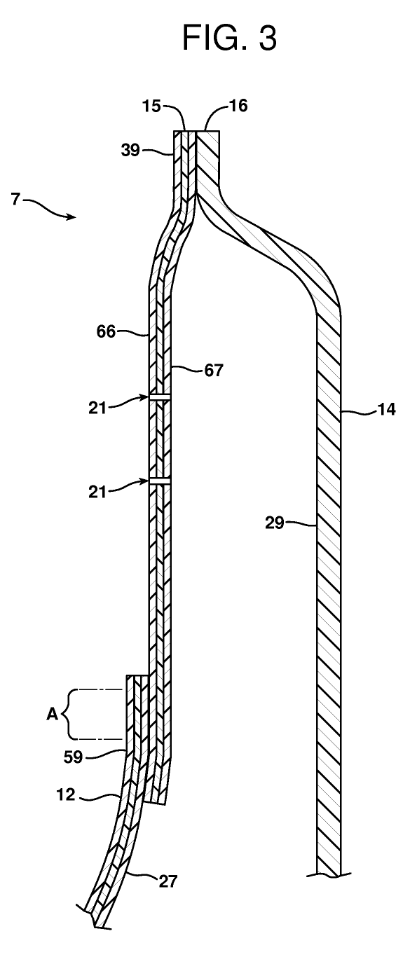

The discrete panel section 6 is anchored to the first side panel. In one embodiment, panel section 6 is anchored to the inner surface 27 of first side panel 12 in anchor region “A” (see FIGS. 2A and 3).

In embodiments disclosed in the drawings, the first portion of the first outer surface of the panel section is closer to the first end of the pouch than the second portion. In some embodiments, the second portion of the outer surface is anchored to the inner surface of the first side panel at anchor region “A”.

Alternatively, discrete panel section 6 is anchored to the first side panel by sealing a second part of the inner surface 67 of discrete panel section 6 to the outer surface 59 of first side panel 12.

C. Opening Mechanisms and Discrete Panel Section Construction

The package of the invention can be easily manually opened. Any suitable mechanism or combination of mechanisms for obtaining this functionality and feature can be used according to the invention. The following are examples of such mechanisms.

1. Adhesive Failure

In this embodiment, inner surface 67 of panel section 6 and inner surface 29 of second side panel 14 each comprises a polymeric composition that, when surface 67 is sealed to surface 29, forms an easy-open seal. This seal provides an interface that breaks apart upon manually opening the package. The interlaminar bonds between layers of the panel section itself (where the panel section is of multilayer construction), the cohesive strength of each layer within the panel section or of the single layer of a monolayer panel section, and the anchor that holds outer surface 66 of panel section 6 to inner surface 27, are stronger than the seal that holds surface 67 to surface 29.

In some embodiments, the polymeric composition of surfaces 67 and 29 will be the same or similar. Useful in these embodiments are the peel systems disclosed in U.S. Pat. No. 4,189,519 (Ticknor) (blend of EVA or EMA or EEA with crystalline isotactic polybutylene, and optionally with anhydride grafted EVA); U.S. Pat. No. 4,252,846 (Romesberg et al.) (blend of EVA and HDPE, optionally with IO or polybutylene (PBU)); U.S. Pat. No. 4,550,141 (Hoh) (blend of IO and polypropylene/ethylene copolymer (EPC)); U.S. Pat. No. 4,666,778 (Hwo) (three component blend of PE, that can be LLDPE, LDPE, MDPE, or HDPE, or EVA or EMA, with PBU, and PP or EPC); U.S. Pat. No. 4,882,229 (Hwo) (butene-1 polymer or copolymer blended with modified or unmodified LDPE); U.S. Pat. No. 4,916,190 (Hwo) (blend of butylene polymer or copolymer, with PE polymer or copolymer (LLDPE, LDPE, MDPE, EVA, EMA, EEA, EBA, or HDPE), with propylene polymer or copolymer); U.S. Pat. No. 4,937,139 (Genske, et al.) (propylene polymer or copolymer blended with HDPE); U.S. Pat. No. 5,547,752 (Yanidis) (blend of PBU and IO); and U.S. Pat. No. 5,997,968 (Dries et al.)(blend of Component 1 (a copolymer of ethylene and propylene or ethylene and butylene or propylene and butylene or ethylene and another -olefin having 5 to 10 carbon atoms or propylene and another -olefin having 5 to 10 carbon atoms or a terpolymer of ethylene and propylene and butylene or ethylene and propylene and another -olefin having 5 to 10 carbon atoms) and Component 2 (HDPE, MDPE, LDPE, LLDPE or VLDPE); these U.S. patents all incorporated herein by reference in their entirety.

In other embodiments, the composition of surfaces 67 and 29 will differ, i.e. dissimilar sealants are used. Useful in these embodiments are the peel systems disclosed in U.S. Pat. No. 3,655,503 (Stanley et al.) (LDPE or MDPE sealed to polypropylene (PP), EPC, saran, nylon 6, polycarbonate (PC), polyvinyl chloride (PVC), or polyethylene oxide (PEO); PP sealed to saran, nylon 6, PC, PVC, PEO, IO, phenoxy, or EVA; or nylon sealed to IO); U.S. Pat. No. 4,729,476 (Lulham et al.) (a blend of EVA and IO sealed to IO); U.S. Pat. No. 4,784,885 (Carespodi) (PP, HDPE, or LLDPE sealed to substantially linear PE (HDPE, LLDPE) blended with a polyolefinic thermoplastic elastomer such as ethylene propylene diene monomer (EPDM), EPM, butyl rubber, halogenated butyl rubber, isoprene rubber, and styrene butadiene rubber); U.S. Pat. No. 4,859,514 ((Friedrich et al.) (IO or IO blended with EVA, sealed to a blend of EVA and ethylene butene copolymer (EBC) and PP); U.S. Pat. No. 5,023,121 (Pockat, et al.)(a blend of PBU and PP and a third polymeric material selected from EVA, LDPE, LDPE, and IO, sealed to EVA, LDPE, LLDPE, or IO); these U.S. patents all incorporated herein by reference in their entirety.

In an alternative embodiment, instead of or in addition to the polymeric composition disclosed above, a removable adhesive, such as certain PSA materials, can be coated on one or both surfaces that are to be adhered, i.e. an external surface of a discrete panel section and/or web as desired, to provide the easy-open seal mechanism.

Alternatively, the seal between surfaces 66 and 27, instead of or in addition to the seal between surfaces 67 and 29, can function as the easy-open seal.

2. Delamination Failure

In this embodiment, one of the interlaminar bonds between layers of the panel section itself (where the panel section is of multilayer construction) can be broken. Thus, the interlaminar bond provides the interface that will break apart upon manually opening the package. The seal between surfaces 67 and 29, and between surfaces 66 and 27, and the cohesive strength of each layer within the panel section, are stronger than the interlaminar bond. Useful in this embodiment are the peel systems disclosed in U.S. Pat. No. 4,944,409 (Busche et al.), this patent incorporated herein by reference in its entirety.

3. Cohesive Failure

In this embodiment, one of the layers of the panel section itself (where the panel section is of multilayer construction) or the monolayer panel section, fractures when the package is opened. The seal between surfaces 67 and 29, and between surfaces 66 and 27, and the interlaminar bonds between layers of the panel section itself (where the panel section is of multilayer construction) are stronger than the layer that fractures. Useful in this embodiment is the peel system disclosed in U.S. Pat. No. 6,476,137 (Longo) (internal rupture of a sealant layer comprising a blend of an ionomer having a melt flow index of less than 5, and a modified ethylene/vinyl acetate copolymer having a substantially higher melt flow index, where the melt flow indices of the two polymers in the seal layer differ by at least 10), this patent incorporated herein by reference in its entirety.

Other peel systems useful in connection with the present invention are those disclosed in U.S. Pat. No. 4,058,632 (Evans et al.), U.S. Pat. No. 4,615,926 (Hsu et al.); U.S. Pat. No. 5,128,414 (Hwo); U.S. Pat. No. 6,395,321 (Schaft et al.), U.S. Pat. No. 7,055,683 (Bourque et al.), and US Patent Publication Nos. 20030152669 (Vadhar et al.) and 2008/0260305 (Shah et al.) (disclosing as easy-open sealant), DuPont APPEEL™ resins, such as those based on EVA, modified EVA, EAA, or modified EAA; polyethylenes such as LDPE and/or EVA blended with PP; LDPE or EVA blended with polybutene-1, or random propylene/ethylene copolymer blended with polybutene-1; EVA or LDPE blended with PP; LDPE blended with EVA and PP; such blends provide an easy-open sealant when adhered to polyethylene sealants); these U.S. patents and publications all incorporated herein by reference in their entirety.

The panel section 6 can have any suitable number of layers. In FIGS. 2A and 3, a panel section 6 has three layers. The layer closest to the interior of the package comprises in one embodiment a polymeric composition that provides an easy-open seal when sealed at surface 67 to inner surface 29. The layer closest to the exterior of the package comprises in one embodiment a polymeric composition that exhibits a relatively strong seal when sealed at surface 66 to inner surface 27. In any panel section construction, alternatively the outermost layer or its equivalent can provide the easy-open seal, and the innermost layer or its equivalent can provide the relatively strong seal, when sealed to respective web inner surfaces. Alternatively, both the innermost and outermost layers or their equivalents provide an easy-open seal.

Alternatively, panel section 6 is of monolayer construction, with innermost and outermost surfaces 66 and 67 like those disclosed herein for a multilayer panel section.

Referring to FIGS. 2A and 3, panel section 6 is anchored to a portion of first side panel 12. In one embodiment, panel section 6 is anchored to the inner surface 27, e.g. with a relatively strong heat seal, at anchor region “A”. The inner surface 67 of panel section 6 is in one embodiment sealed to inner surface 29 of second side panel 14 with an easy-open seal.

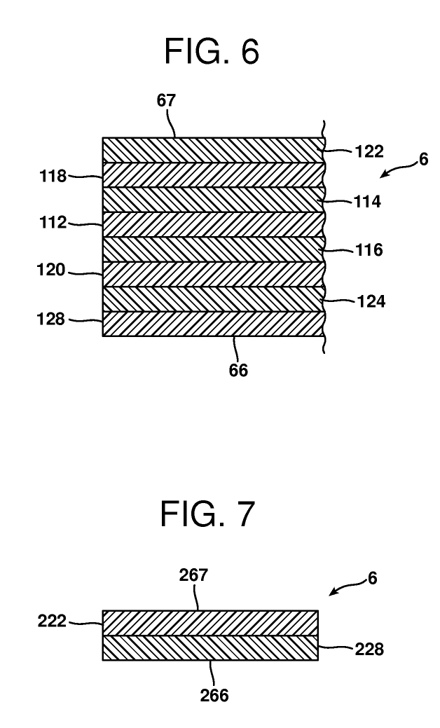

A representative film structure “A1” suitable for use as the panel section 6 according to the invention is shown in FIG. 6. In one embodiment, this film has the composition shown in Table 1.

TABLE 1
(Example 1)

| | | Gauge | Gauge | Gauge |
|---|---|---|---|---|
| Layer | Composition | (thickness %) | (mils) | (μm) |
| 122 | EZ1 | 25.00 | 0.50 | 12.7 |
| 118 | AD1 | 7.50 | 0.15 | 3.8 |
| 114 | 80% NY1 + | 7.50 | 0.15 | 3.8 |
| | 20% NY2 | | | |
| 112 | OB1 | 10.0 | 0.20 | 5.1 |
| 116 | 80% NY1 + | 7.50 | 0.15 | 3.8 |
| | 20% NY2 | | | |
| 120 | AD1 | 7.50 | 0.15 | 3.8 |
| 124 | 65% AD2 + | 17.50 | 0.35 | 8.9 |
| | 35% PE1 | | | |
| 128 | PE1 | 17.50 | 0.35 | 8.9 |

This example of a material suitable as the panel section 6 is a barrier film with an easy-open sealant, and is currently used as a barrier/easy-open component of various laminated materials that also include a polyester film component, sold commercially by the Cryovac business unit of Sealed Air Corporation, under designations including H52XXBZ, and H72XXBZ. These are sold as primary packaging materials, i.e. webs that form the main body of the package, not as discrete laminates to be used in combination with a primary web.

When used according to the invention, the easy-open sealant layer 122 of A1 exhibits a peel force of typically about 2 pounds/inch (ASTM F88). Layer 128 of A1 yields a peel force of typically 8 pounds/inch.

The resins disclosed in Table 1 are identified in Table 2.

TABLE 2

| Material | Tradename Or | |
|---|---|---|
| Code | Designation | Source(s) |
| AD1 | PLEXAR ™ PX1007 ™ | Equistar |
| AD2 | BYNEL ™ 39E660 ™ | DuPont |
| EZ1 | APPEEL ™ 72D727 | DuPont |
| NY1 | ULTRAMID ™ B33 01 | BASF |
| NY2 | GRIVORY ™ G21 | EMS |
| OB1 | SOARNOL ™ ET3803 | Nippon Gohsei |
| PE1 | PE ™ 1042cs15 | Flint Hills |

AD1 is a maleic anhydride modified EVA that acts as a polymeric adhesive (tie layer material).

AD2 is a maleic anhydride modified EVA that acts as a polymeric adhesive (tie layer material).

EZ1 is a compound polymer blend of 65% ionomer (SURLYN™ 1650SB), 30% EVA (ELVAX™ 3134Q), and 5% polybutylene (MONTELL™ PB8640), each by weight of the blend.

NY1 is nylon 6 (polycaprolactam).

NY2 is an amorphous copolyamide (61/6T) derived from hexamethylene diamine, isophthalic acid, and terephthalic acid.

OB1 is EVOH with about 38 mole % ethylene.

PE1 is LDPE.

Example 1 as shown has a total thickness ranging from about 2.0 mils to 3.5 mils.

Core layer 112 of the above film structure can comprise any suitable oxygen barrier material, such as EVOH, and can be blended in any suitable proportion with other polymeric materials or organic or inorganic additives as desired. In one embodiment, intermediate layers 114 and 116 can each comprise 100% semicrystalline polyamide such as nylon 6.

In another embodiment, Intermediate layers 114 and 116 each comprise a blend of an amorphous polyamide and a semicrystalline polyamide.

Tie layers 118 and 120 can comprise any suitable polymeric adhesive that functions to bond two layers together, e.g. EVA, EAO, LDPE, EMA, and anhydride grafted derivatives of these polymers. Tie layers 118 and 120 can be the same, or can differ.

Bulk layer 124 can comprise a suitable polyolefin, such as an EAO; and/or a polymeric adhesive such as those disclosed herein for tie layers 118 and 120.

In one embodiment, first outer layer 122 functions as an easy-open sealant layer of the film, and provides a surface 67 that can be sealed to the inner surface 29. Layer 122 can comprise any suitable material or blend of materials that provides an easy-open peelable seal when adhered to the inner surface 29. Layer 122 comprises EZ1 or any suitable resin or resin blend that provides an easy-open peelable sealant.

Second outer layer 128 can function as a sealant layer of the film, and provides a surface 66 that can be sealed to the inner surface 27 of first side panel 12. Layer 128 can comprise any suitable material or blend of materials that provides a relatively strong seal when adhered to inner surface 27. Layer 128 comprises PE1 or any EAO such as EXACT™ 3024, a single-site catalyzed linear ethylene/butene copolymer from ExxonMobil with a density of 0.905 g/cc; or AFFINITY™PL 1888G, a single-site catalyzed branched ethylene/octene copolymer from Dow with a density of 0.9035 g/cc.

Additional materials that can optionally be incorporated into one or more of the film layers, as appropriate, include antiblock agents, slip agents, antifog agents, fillers, pigments, dyestuffs, antioxidants, stabilizers, processing aids, plasticizers, fire retardants, UV absorbers, etc.

Alternatively, layer 122 can be sealed to inner surface 27, and layer 128 can be sealed to inner surface 29.

In general, panel section 6 can have any total thickness desired, and each layer can have any thickness desired, so long as the panel section and package provide the desired functionalities. Typical total film thicknesses are from 0.1 mils to 15 mils, such as 0.2 to 12 mils, such as 0.5 mils to 10 mils, 0.8 mils to 8 mils, and 1 mil to 4 mils. Suitable gauges include 1.5 mils, 2 mils (as in Example 1); and 3 mils.

Thus, by way of example, FIG. 7 shows, in another embodiment, a two layer film 210 having a first outer layer 222 compositionally and functionally like layer 122 of FIG. 6, with a first outer surface 267; and having a second outer layer 228 compositionally and functionally like layer 128 of FIG. 6, with a second outer surface 266.

Two, three, four, five, six, seven, and eight layer films can thus alternatively be produced, that each include the layers described above with respect to the film of FIG. 7, with additional layers as needed, using suitable polymers such as olefin homopolymers or copolymers.

In some embodiments, such as the panel section of FIG. 7, an oxygen barrier layer is not necessary, for example in the packaging of produce. In these embodiments, the web or webs that comprise the pouch will typically also not have an oxygen barrier layer. In contrast, embodiments of panel section 6 that include an oxygen barrier layer will typically be suitable in connection with web or webs for the pouch that include an oxygen barrier layer.

FIG. 3 is similar to FIG. 2A, but in which the second surface 67 of panel section 6 is not sealed to inner surface 29 of second side panel 14, except by side (perimeter) seals (see e.g. seals 30 and 32 of FIGS. 4 and 5). The embodiment of FIG. 3 offers the benefit of more usable space inside the package, because there is no seal (except at the perimeter of the package) of surface 67 to surface 29, and therefore more space is available for product.

In each of the embodiments of the package and process disclosed herein, a nonhermetic or hermetic package can be made in accordance with the invention.

Another material useful for panel section 6 is a barrier film with a sealant that provides a relatively strong seal, and is currently used as a barrier/sealant component of various laminated materials that also include a polyester film component, sold commercially by the Cryovac business unit of Sealed Air Corporation, under designations including H52XXB, and H72XXB. These are sold as primary packaging materials, i.e. webs that form the main body of the package, not as a panel section to be used in combination with a primary web.

At least one open-loop or close-loop die cut is disposed on the discrete panel section. Two or more die cuts can be disposed on the discrete panel section in any suitable configuration. To open a package, a die-cut segment of material can thus be displaced or entirely removed from the discrete panel section, exposing an upper edge of the panel section. This upper edge can then be grasped and pulled up or removed, allowing access to the contents of the package.

2. Method of Making a Package

A. Horizontal Form/Fill/Seal (HFFS)

HFFS packaging systems are generally well known to those of skill in the packaging industry, and can be used to make packages of the present invention.

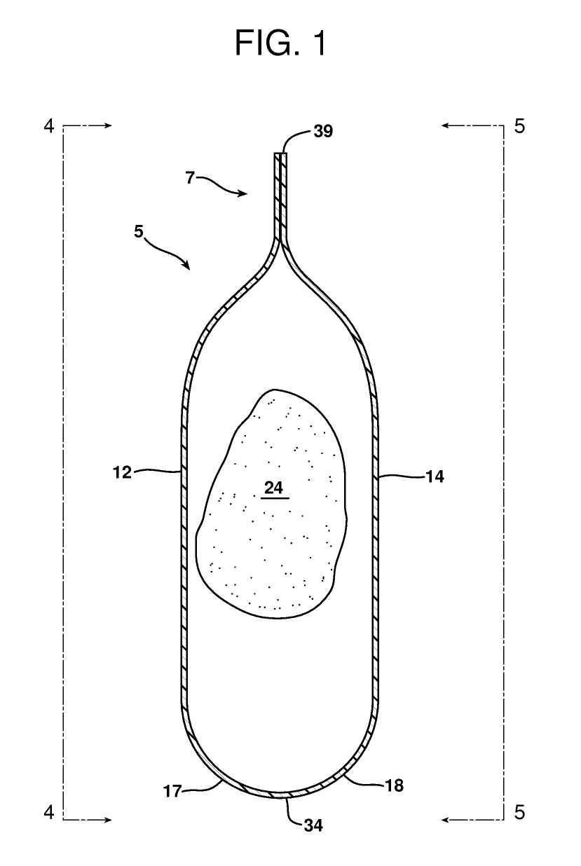

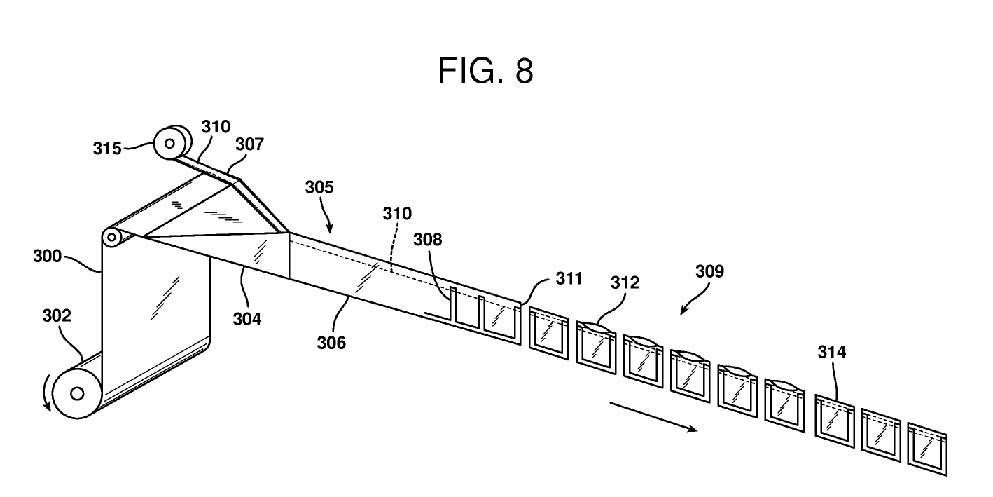

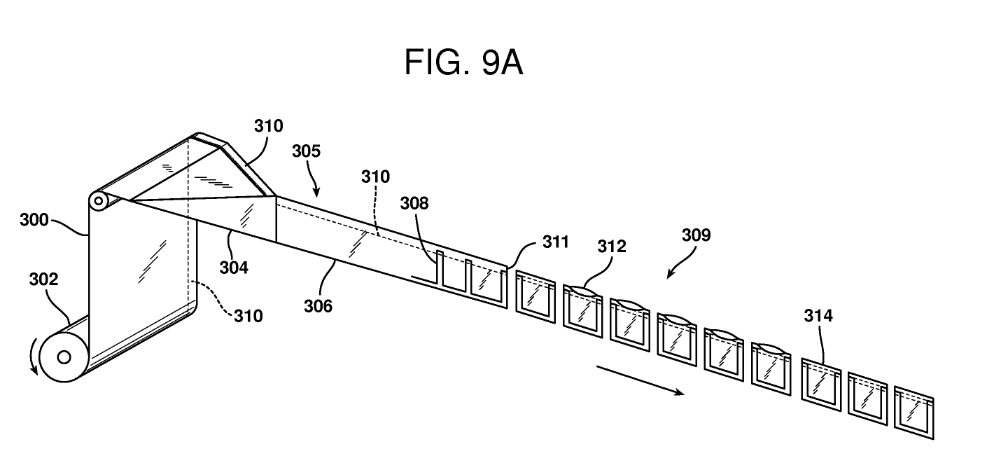

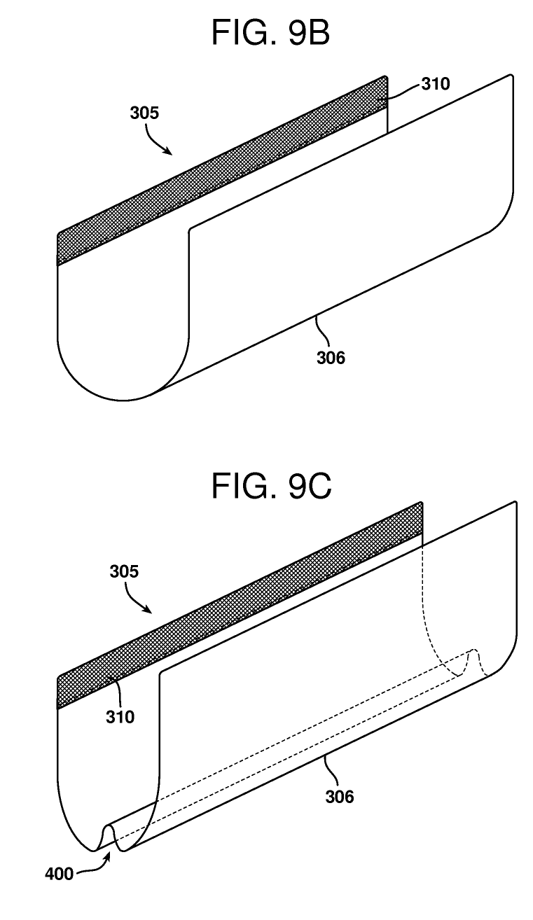

Referring to FIGS. 8, and 9A through 9C, lay-flat web 300 is unwound from roll 302, then advanced to forming plow 304 to convert lay-flat web 300 to folded web 305 (typically a centerfold film). The second end of each of the pouches to be made will comprise a second end fold 306. Second end fold 306 therefore is equivalent to second end 34 of FIG. 1. This second end fold can be optionally sealed, or left as a folded second end of the pouch. Side seals 308 are made to define a plurality of vertically arranged pouches 309. Each pouch 309 is cut off from the trailing edge of web 300 by an appropriate cutting mechanism (not shown) such as a knife, at position 311, a product (not shown in FIG. 8, but see product 24 in FIGS. 1 to 5) is inserted or dropped into the open mouth 312 of each pouch, and the pouch mouth 312 is then closed by a suitable sealing mechanism such as a heat sealer (not shown) to create a seal 314.

Discrete panel section 310, equivalent to discrete panel section 6 of FIGS. 1 to 5, can be introduced into the HFFS process in a number of ways. For example, discrete panel section 310 can be unwound from a roll 315 in the vicinity of roll 302, and disposed on lay-flat web 300 prior to, or as web 300 is being folded into folded web 305. The discrete panel section is disposed on the web such that the discrete panel section overlaps the lay-flat web sufficient to allow the discrete panel section to be anchored to the web.

Discrete panel section 310 includes an inner surface 67 (see FIG. 2A) comprising an easy-open sealant. A second portion of the outer surface of the panel section is anchored to the inner surface of the folded web at a second location on the folded web, by a suitable sealing mechanism such as a heat sealer (not shown). Alternatively, a second portion of the inner surface of the panel section is anchored to the outer surface of the folded web. The inner surface of the panel section is sealed to the inner surface of the folded web. Discrete panel section 310 would thus be installed on the pouch in the same overall HFFS process that achieves production of the pouch, loading of a product into the pouch, and completion of the final package. Discrete panel section 310 is incorporated onto the pouch material and after cutting and sealing as described hereinabove, comprises an extension of the first side panel of each pouch as shown in FIGS. 8, and FIGS. 1 to 5.

Alternatively, and referring to FIG. 9A, discrete panel section 310 is shown as being installed on the lay-flat web prior to the start of the HFFS packaging process. This can be accomplished off-site from the processor, e.g. by the supplier of the web roll 302.

FIG. 9B is a perspective view of a section of folded web as shown in the HFFS process and apparatus of FIGS. 8 and 9A, as the lay-flat web is folded to create folded web 305. The discrete panel section 310 is shown disposed on, and optionally attached to, an inner surface 27 of one panel 12 of the folded web 305, such that upon sealing the web to create a pouch, the discrete panel section functions as an extension of the panel.

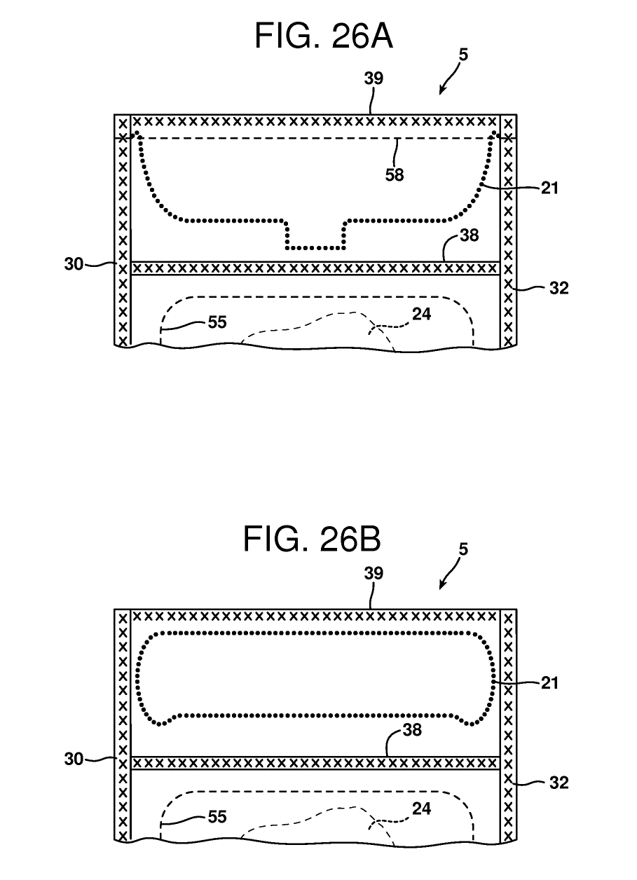

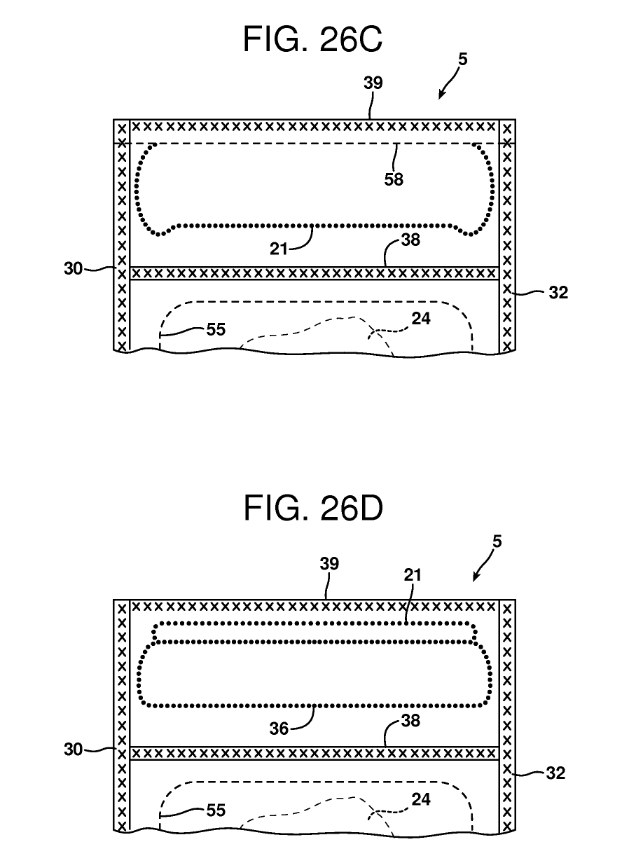

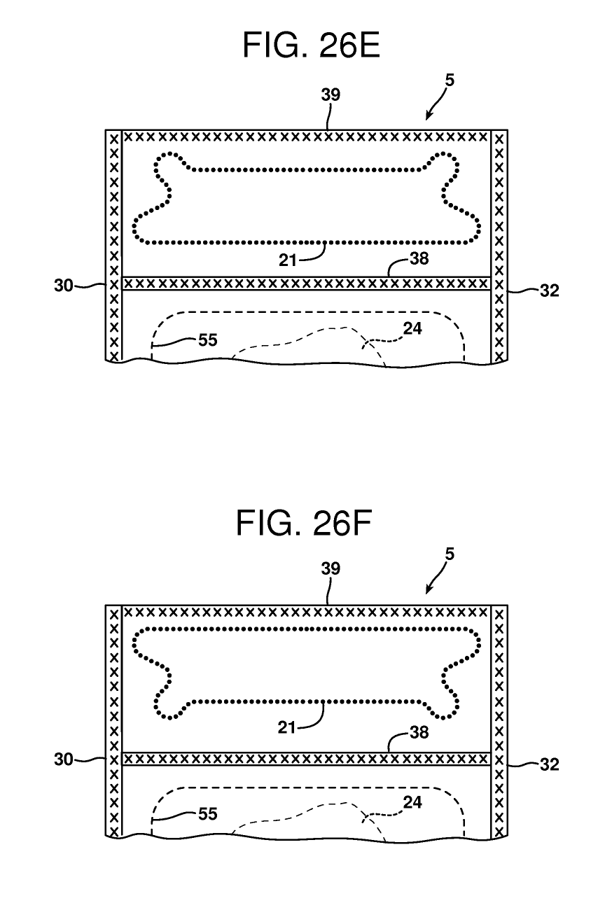

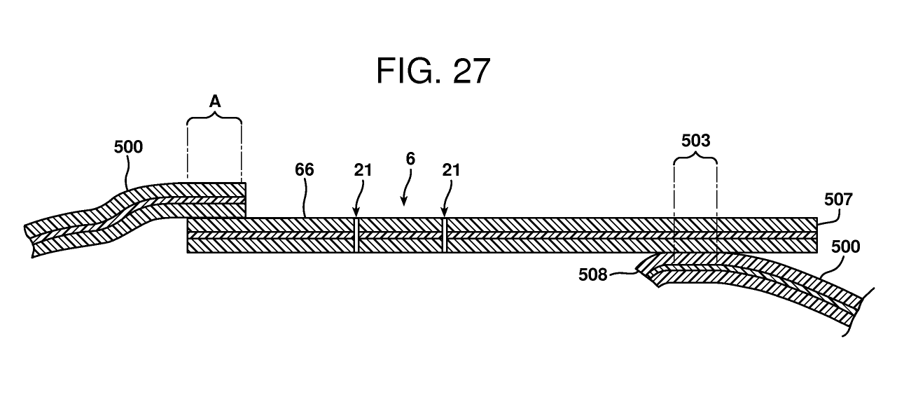

The embodiment of FIG. 9C is similar to FIG. 9B, but additionally shows an optional gusset 400 that can be made in the second end fold 306 of the folded web. The gusset can be optionally thereafter heat sealed. A gusseted second end provides a stand-up pouch feature in the final package. Gusseting can be accomplished by any suitable means known to those of skill in the art, such as a second forming plow (not shown) placed in-line in the manufacturing line at a position downstream of the forming plow 304. The bottom area of the folded web takes on a generally “W” shape, i.e. a gusseted shape, in cross-section, with the outside legs of the “W” extending upwardly, and two parallel reverse folds to create the gusseted bottom. Seal opening or holes are previously punched in the inner legs of the “W” shape and aligned with one another so that the two outside plies can be sealed together through these holes. When the seals are made the panels are sealed to one another through the holes. One or more static plows may be mounted above the seal zone to form the gussets. Gusset holes can be die punched by a die at a hole-punch station which punches clearance holes at an appropriate position designed to be in general alignment with the side seal, adding rigidity to the gusset portion of the final package. This added rigidity enables the final package to stand up by itself when placed on a flat surface. The discrete panel section includes die cut(s) made in any suitable predetermined pattern (see e.g. FIGS. 26A to 26F) to produce packages according to the invention.

B. Vertical Form/Fill/Seal (VFFS)

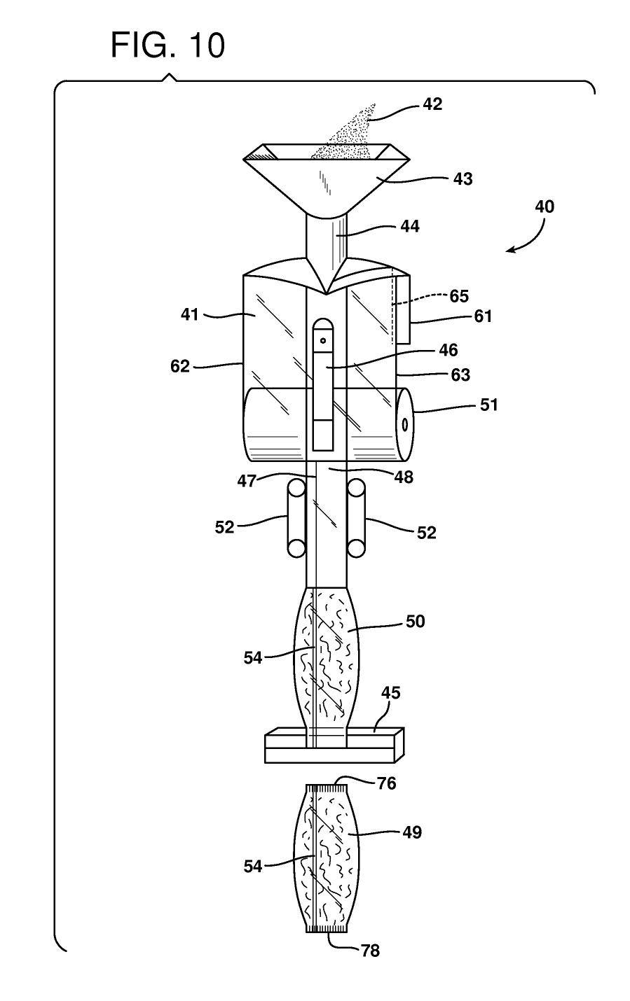

FIG. 10 schematically illustrates a VFFS apparatus that can be used in conjunction with the apparatus and process according to some embodiments of the present invention. VFFS packaging systems are generally well known to those of skill in the art, and described for example in U.S. Pat. No. 4,589,247 (Tsuruta et al), U.S. Pat. No. 4,656,818 (Shimoyama et al.), U.S. Pat. No. 4,768,411 (Su), and U.S. Pat. No. 4,808,010 (Vogan), all incorporated herein by reference in their entirety.

Apparatus 40 utilizes a lay-flat web 41 as a rollstock. Product 42 is manually or mechanically supplied to apparatus 40 from a source (not illustrated), from which a predetermined quantity of product 42 reaches the upper end portion of forming tube 44 via funnel 43, or other conventional means. The packages are formed in a lower portion of apparatus 40, and web 41 from which the packages are formed is fed from feed roll 51 over certain forming bars (not illustrated), is wrapped about forming tube 44 (sometimes known as a “sailor's collar” or “forming collar”) and is provided with a longitudinal fin seal or lap seal 47 by longitudinal heat sealing device 46, resulting in the formation of a vertically-oriented folded web in the form of a tube 48. Transverse heat seal bars 45 operate to close and seal horizontally across the lower end of vertically-sealed tube 48, to form a pouch 49 which is thereafter packed with product 42. Film drive belts 52, powered and directed by rollers, as illustrated, or by suitable alternative motive means, advance tube 48 and pouch 49 a predetermined distance, after which seal bars 45 close and simultaneously seal horizontally across the lower end of vertically-sealed tube 48 as well as simultaneously sealing horizontally across upper end of sealed pouch 49, to form a product packaged in sealed pouch 49. The next pouch 50, thereabove, is then filled with a metered quantity of product 42, forwarded, and the packaging cycle is repeated. It is conventional to incorporate with the seal bars 45 a cut-off knife (not shown) which operates to sever a lower sealed pouch 49 from the bottom of upstream pouch 50.

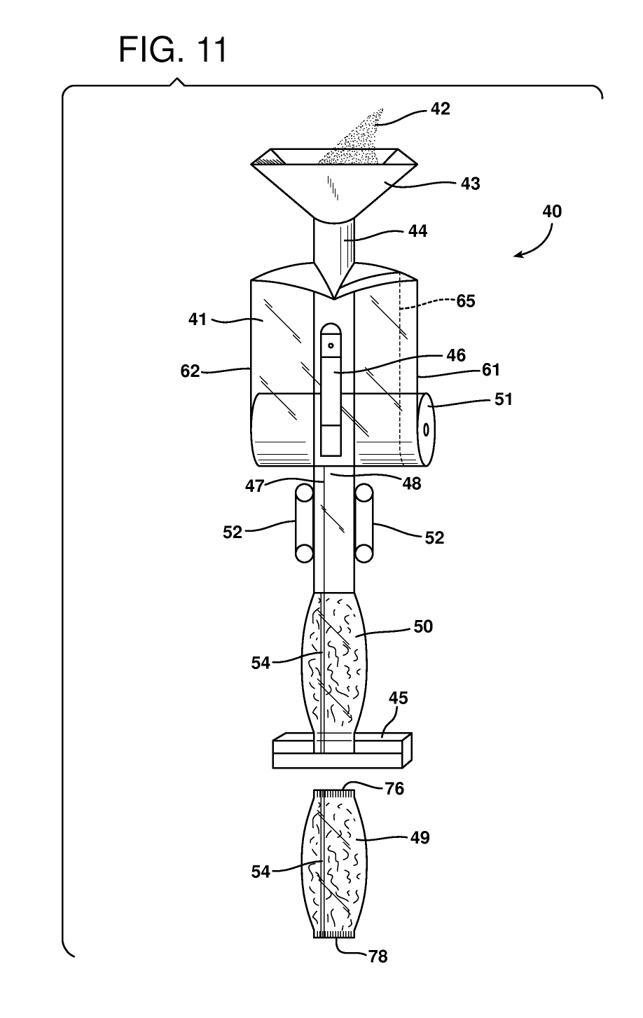

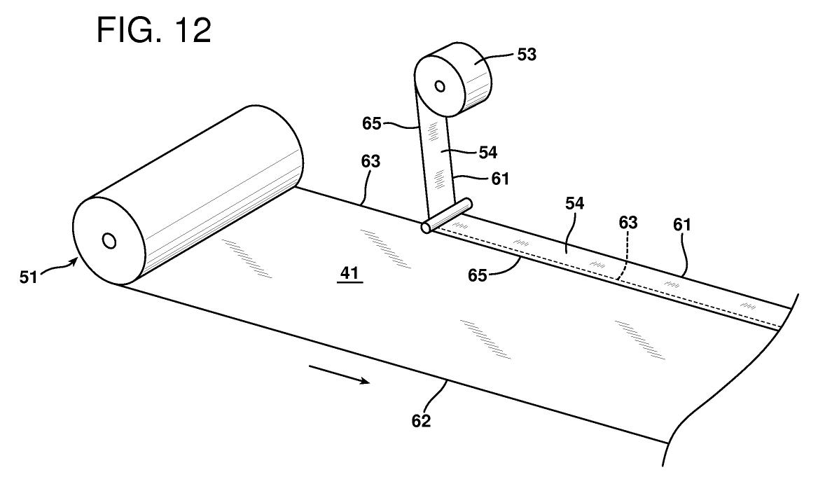

Lay-flat web 41 of FIGS. 10 and 11 will in operation travel upward, e.g. vertically upward from roll 51 to the forming tube 44, and then downward, e.g. vertically downward for the remaining process steps. Discrete panel section 54 (like panel section 6) is unwound from roll 51 (FIG. 12) to dispose discrete panel section 54 in overlapping relationship onto web 41 before, or as, web 41 is wrapped about forming tube 44. Longitudinal seal 47 is made, and discrete panel section 54 is aligned with and attached to the longitudinal edge of the folded web.

FIG. 12 discloses the roll 51 of lay-flat web 41 according to one embodiment of the invention. Discrete panel section 54 is fed from roll 53 onto a portion of lay-flat web 41.

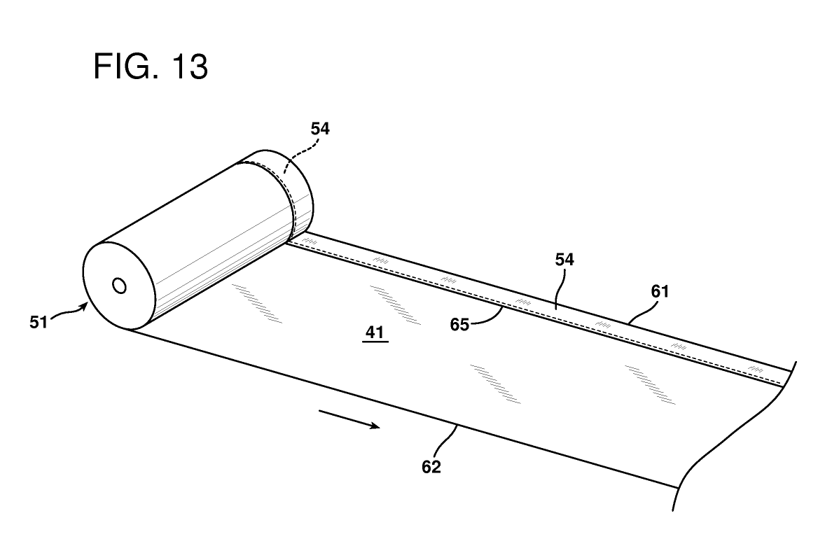

Alternatively, and referring to FIGS. 11 and 13, discrete panel section 54 is already installed on the lay-flat web prior to the start of the VFFS packaging process. This can be accomplished off-site from the processor, e.g. by the supplier of the feed roll 51.

The discrete panel section includes die cuts made in any suitable predetermined pattern (see e.g. FIGS. 26A to 26F) to produce packages according to the invention.

In some embodiments, at least one of the web and the discrete panel section carries a registration device. Printed indicia can be in the form of registration marks, such as eyespots. Those skilled in the art will be familiar with the use of eye-spots and registration marks in processing web material in packaging operations. Registration marks are printed in uniformly spaced fashion along or near an edge of the web or discrete panel section, and facilitate the controlled production of packages of the invention, and can be printed in conjunction with other decorative printing.

The discrete panel section in accordance with the invention includes an outer surface, an inner surface, a first side edge, a second side edge, a first end, and a second end; can have any suitable dimensions; can be anchored to a web or first side panel of a package of the invention; and can serve as an upper or end portion extension of a first side panel of a package that can function as a removable flap, and/or as a component that can be sealed to the second side panel.

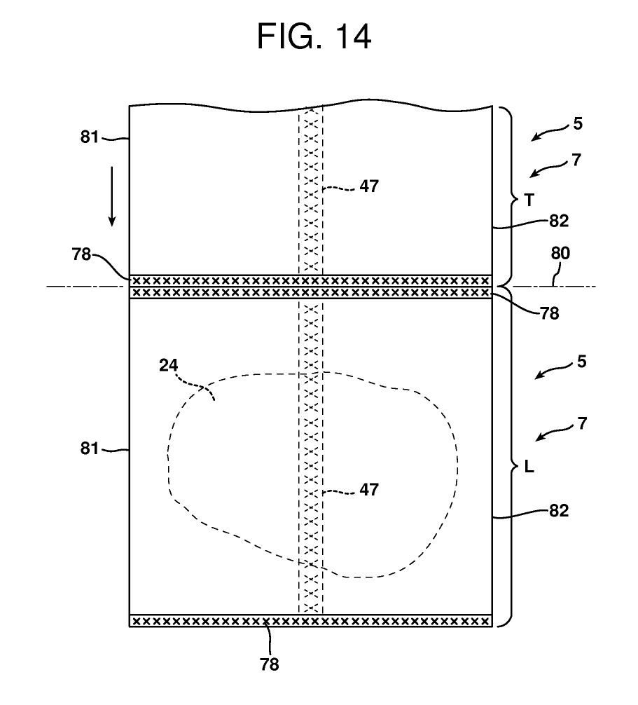

In FIG. 14, a discrete panel section can be installed on a leading or downstream pouch “L” includes a transverse bottom and top seals 78, folded side edges 81 and 82, and longitudinal seal 47. Trailing or upstream pouch “T” has features similar to leading pouch “L”. Leading pouch “L” is severed from upstream pouch “T” at cut line 80, and the seals 78 are made by suitable sealing equipment commonly used in VFFS packaging processes, such as heat sealing equipment, not shown. For the sake of clarity, die cuts 21, present in the panel section of the package, are not shown in all of the drawings. The discrete panel section is not shown in FIG. 14.

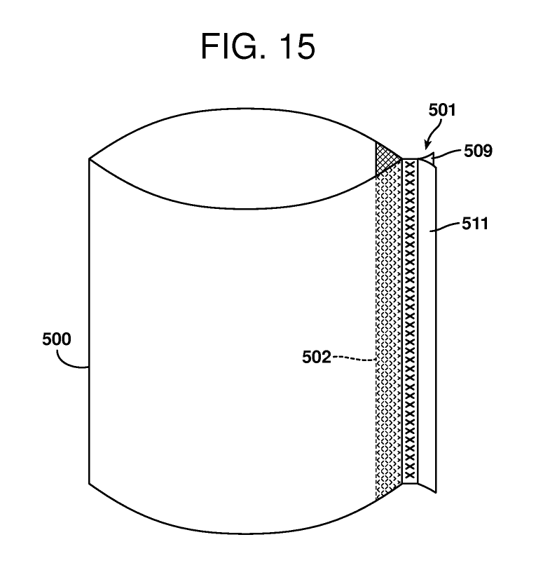

FIG. 15 shows folded web 500 with a discrete panel section 502 anchored to the folded web, and fin seal 501, formed as disclosed hereinabove, and prior to a step of making transverse seals in the folded web. A finished package made according to FIG. 15 will thus look like the packages of FIGS. 4 and 5, when these are viewed at right angles to their position in FIGS. 4 and 5, i.e. with the discrete panel section 6 to the right side of each package, and the second end 34 representing a fold. The embodiment of FIG. 15 thus provides a method of producing packages on a VFFS apparatus where the longitudinal seal of the package effectively becomes the first end of the finished package (discounting any unsealed material between the longitudinal seal and the top edge of the package). The apparatus and methodology of U.S. Pat. No. 6,293,073 (Caudle) this patent incorporated herein by reference in its entirety, can be utilized in combination with the teachings herein, to produce packages according to this embodiment. A point of distinction is that in the present invention, the transverse seals will typically (although not necessarily) be rectilinear, whereas the transverse seals disclosed in Caudle '073 are wavy or sinusoidal.

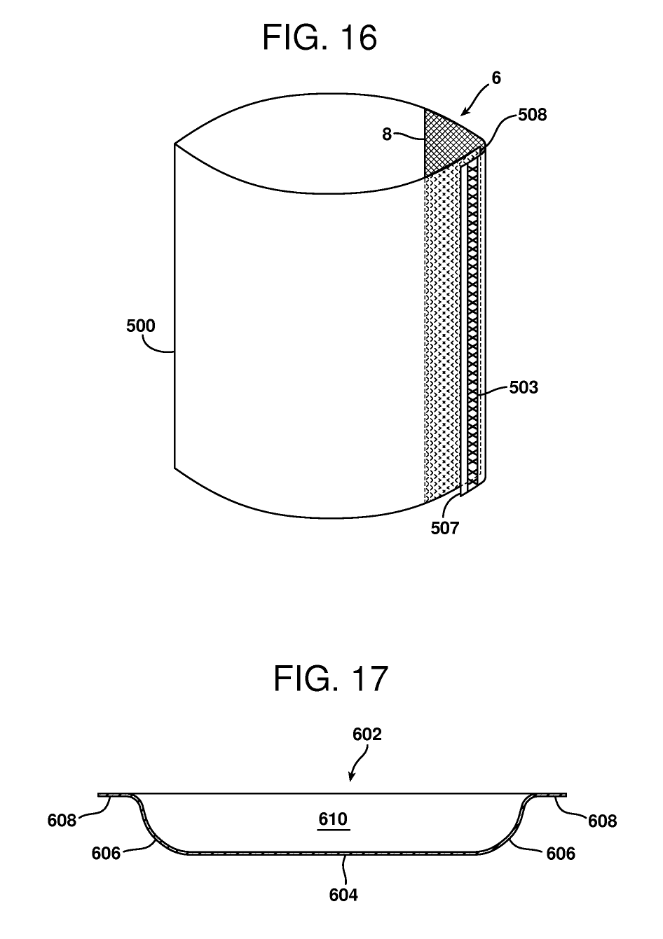

Alternatively (FIG. 16), a package like the embodiment of FIG. 15 is shown, but where a lap seal 503 is shown. In this as well as the other processes disclosed herein, a lap seal can be used in lieu of a fin seal when making a longitudinal seal according to the invention.

A finished package 5 according to FIG. 16 has a product therein; the two longitudinal ends of the package are closed by a transverse seal; the lap seal runs down the middle or spine of the package, bounded on both ends by the transverse seals; and the discrete panel section is anchored to a surface of the folded web.

C. Lidstock/Formed Web

FIGS. 17, 18, and 19 illustrate in another embodiment the use of a formed web, e.g. a tray, and a non-formed web, e.g. a lidstock, used in connection with the invention. Tray 602 will typically be made during the packaging process. Thermoforming equipment, available from e.g. Multivac, Tiromat, Ulma or Rapid Pak, is used to convert flat thermoplastic forming web into formed pockets to create trays for containing product such as food, various industrial and consumer items and sterile medical products. Trays are formed from a lower web by heat and pressure, and can be loaded with product manually or automatically on the machine. After that, the packages are vacuumized or backflushed with modified atmosphere (if required), hermetically sealed to an upper web, separated, and removed for distribution or storage. Alternatively, pre-formed trays can be used.

Each tray 602 has a tray bottom 504, tray sides 606, and a tray flange 608 along its perimeter to which the lidstock 612 can be sealed by heat or other means. Tray bottom 504 and tray sides 606 define tray cavity 610. Prior to any thermoforming step, tray 602 can be of any suitable thickness, e.g. from 2 to 30 mils thick, and any suitable construction.

If a pre-made tray is used according to the invention, it can be rigid or semi-rigid, can be in the form of a flat or shaped tray, and can be made from any suitable material, including solid or expanded embodiments, such as PP, polystyrene, polyamide, 1,4-polymethylpentene (e.g. TPX™ available from Mitsui), or crystallized polyethylene terephthalate (CPET). A tray liner can optionally be used that adheres to the surface of the pre-made tray on which the product is to be placed. This liner can be of any suitable design, and can be a multi-layer structure with at least one layer with gas-barrier properties. Such a liner can be adhered to the tray by heat lamination, extrusion lamination, extrusion coating, adhesives, corona treatment, etc. Tray 602 can be a flexible or semi-rigid, or rigid formed web.

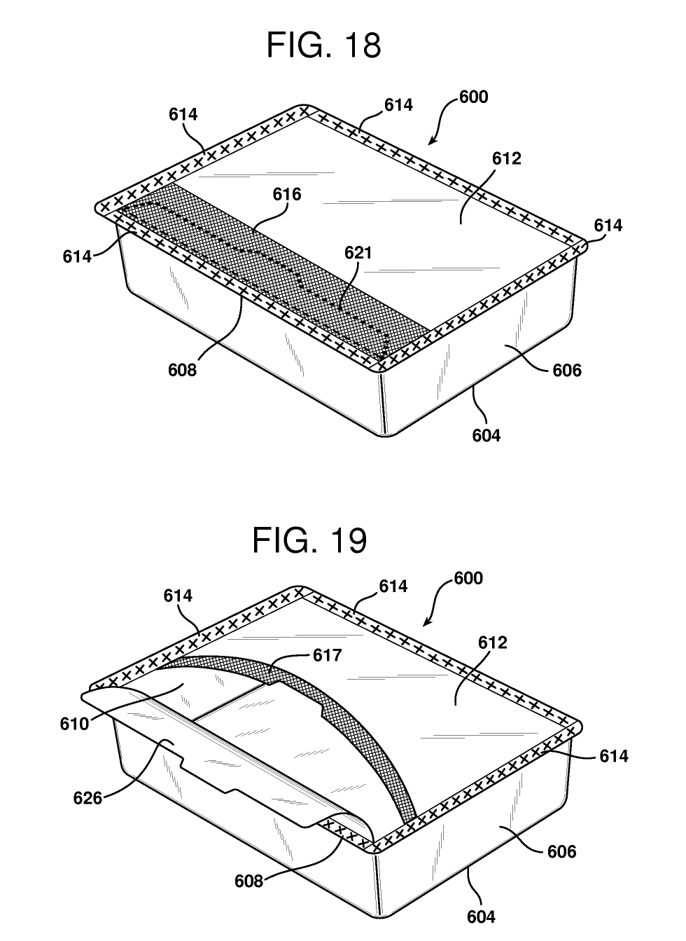

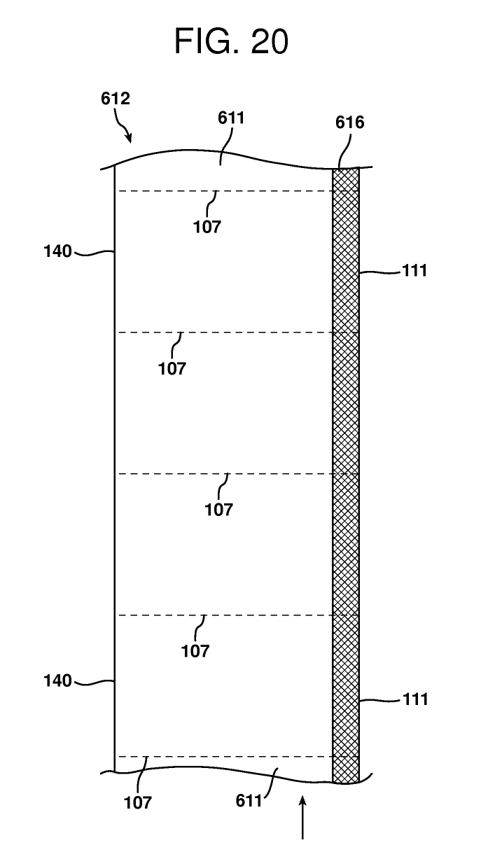

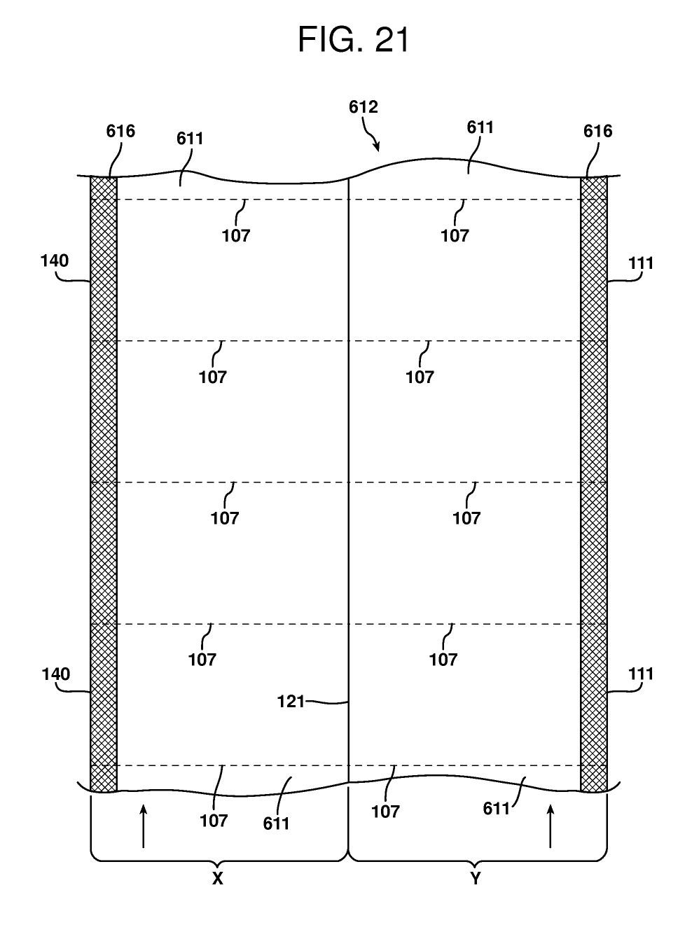

Referring to FIGS. 18 and 19, a package 600 includes tray 602 to which lidstock 612 has been sealed with perimeter seal 614. Lidstock 612 includes a lay-flat web 611 (see FIGS. 20 and 21) formulated to function as a lid on a formed web, and can be any suitable monolayer or multilayer thermoplastic film as described herein with respect to webs useful in connection with the present invention. Lidstock 612 also includes discrete panel section 616 having an easy-open sealant on one surface thereof, and a sealant on a second surface thereof. Discrete panel section 616 has the easy-open characteristics and composition discussed herein with respect to the discrete panel section of HFFS or VFFS packages. The discrete panel section at die cut 621 (see also FIG. 26A) can be pulled back manually toward the end of the package, along hinge line 58, and the first side panel is grasped so that the package is easily opened and product can be removed as desired.

In some embodiments, the die cut can be a closed-loop die cut that can be completely removed when opening the package.

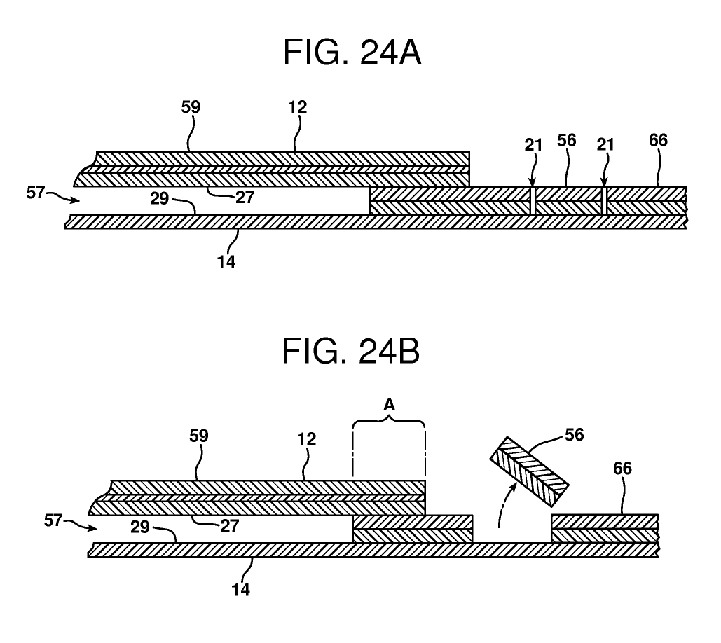

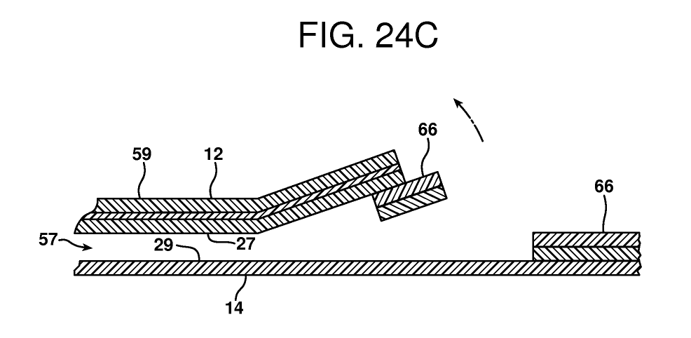

The discrete panel section (see also FIG. 24A to 24C, and 25C to 25D) can be pulled back manually toward or away from the first end of the package, and optionally removed, so that the package is easily opened and product can be removed as desired.

Referring to FIG. 20, discrete panel section 616 has a first lateral edge 111. As shown, discrete panel section 616 has been anchored to the lay-flat web 611 to produce lidstock 612. Dotted lines 107 indicate the location at which lidstock 612 is sealed and cut, e.g. perimeter heat sealed and cut, in registered fashion by otherwise conventional means as discussed herein, e.g. in thermoforming equipment, to create individual packages. Lines 107 represent what will become the side edges and seals of individual packages when lidstock 612 is advanced into a packaging system where it is progressively fed over filled trays, sealed to the trays, and cut to create finished packages. Lines 111 and 140 also represent what will become the first and second end respectively of individual packages. Layflat web 611, as rolled up, and as it feeds into thermoforming equipment, has a first lateral edge 140. Discrete panel section 616 can be preanchored on lay-flat web 611 by the supplier of the lidstock, as in the embodiments of FIGS. 9A, 11 and 13. Alternatively, discrete panel section 616 can be anchored to the lay-flat web 611 during the packaging process, as in the embodiments of FIGS. 8, 10, and 12.

FIG. 21 shows an alternative embodiment of FIG. 20, in which the lidstock is produced as described above, but “two across”, so that when run in a packaging machine, with suitable machine die set-ups, two, four, etc. packages can be made simultaneously. In addition to the seal and cut steps at locations 107, the web is cut longitudinally along line 121, so that individual packages made from the longitudinal portion “X” of FIG. 21 will have a second end 121; and individual packages made from the longitudinal portion “Y” of FIG. 21 will have a second end 121.

D. Continuous Horizontal Packaging

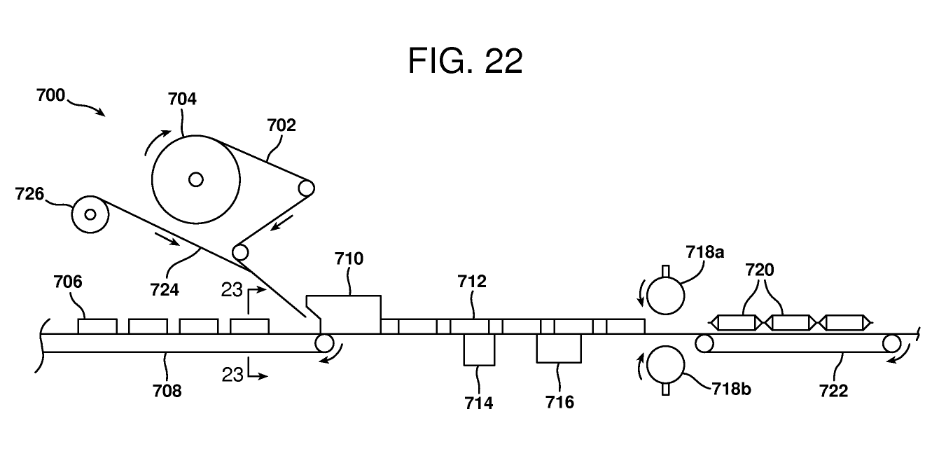

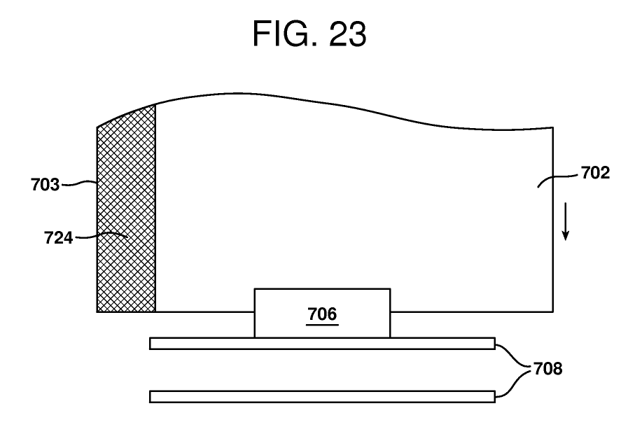

In another embodiment, and referring to FIGS. 22 and 23, the package of the invention can be made using a continuous HFFS process and apparatus such as those used for packaging bakery and other goods, sometimes known as Flow Wrap, Flow-Wrap or Flow wrapping machines or systems, and available from manufacturers/suppliers such as Ilapak, ULMA, and Bosch.

FIG. 22 shows such a process and apparatus 700, but one in which a discrete panel section 724 (like panel section 6) is installed into a package. Lay-flat web 702 is drawn from roll 704 and advanced to forming device 710. As this occurs, a series of products 706 is advanced along conveyor 708 to forming device 710, and discrete panel section 724 is drawn from roll 726 and advanced to forming device 710. Web 702, with the discrete panel section in some embodiments anchored thereto either before or during forming of the web in the forming device, is formed by forming device 710 into folded web 712. This folded web will be like the folded web described above with respect to VFFS embodiments, but in a substantially horizontal orientation. Folded web 712 wraps around products 706. A longitudinal sealing device that can be part of forming device 710 forms a lap or fin seal (of the type disclosed above with respect to VFFS embodiments) on the folded web, typically at the bottom of the folded web. The lap or fin seal is typically a heat seal. An alternative is to have a separate sealing device 714 to produce the lap or fin seal. The products travel downstream from forming device 710 or sealing device 714 to transverse sealing device 716 where the folded web is transversely sealed in areas of the folded web between adjacent products. Such seals are typically heat seals. The products are advanced from transverse sealing device 716 to cutting device 718a and 718b, where the formed and longitudinally and transversely sealed folded web is severed in areas of the folded web between adjacent products, in or near the transverse seals, such that individual packages 720 are produced.

Alternatively, the sealing function of transverse sealing device 716 and the cutting function of cutting device 718a and 718b can be combined at a single station, rather than being performed at separate locations on the production path.

Web 702 and discrete panel section 724 can be of any suitable dimension and composition, such as those disclosed herein. As discrete panel section 724 is fed to forming device 710, it can be brought into contact with, and optionally anchored to a surface of web 702. This embodiment is shown in FIGS. 22 and 23, where the discrete panel section is shown as anchored to web 702 as it progresses toward forming device 710. First longitudinal edge 703 of discrete panel section 724 can be seen in FIG. 23. Alternatively, discrete panel section 724 can be fed into forming device 710, and then incorporated into folded web 712 by anchoring the discrete panel section to a surface of the web adjacent to the area of the formed web in which the lap or fin seal is made, and in a manner and format analogous to the embodiment of the VFFS pouch and package of FIGS. 10, 15 and 16, but in a horizontal rather than vertical position. In another embodiment, discrete panel section 724 can be pre-applied to web 702 by the supplier of the web, analogous to the embodiment of the VFFS pouch and package of FIG. 13, and the HFFS pouch and process of FIG. 9A.

E. Side seal bags

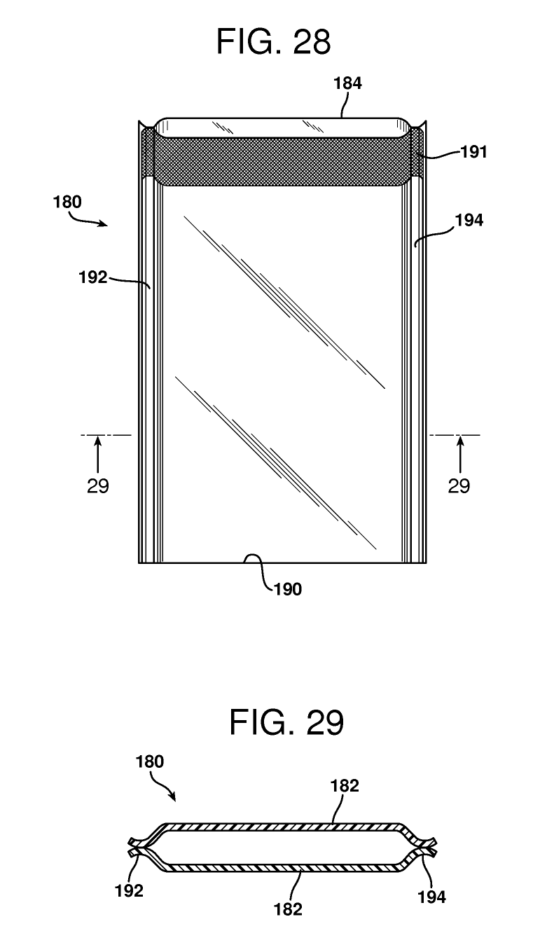

In one embodiment, and referring to FIGS. 28 and 29, the package of the invention can be made using otherwise conventional bag making equipment and processes. Bags are often made as side seal bags. The side seal bag has a factory-made heat seal at opposite bag edges. The bag bottom is formed by one of two folds of film created during the extrusion of bag tubing during manufacture. The opposite fold of film is slit to form a bag mouth. The bag is typically made from a long length of bag tubing. A method of making side seal bags is disclosed in US 2008/0138478 A1 (Ebner et al.), this patent incorporated herein by reference in its entirety.

FIGS. 28 and 29 illustrate bag 180. FIG. 28 illustrates a side seal bag 180, in a layflat view; FIG. 29 illustrates a cross-sectional view taken through section 29-29 of FIG. 28. With reference to FIGS. 28 and 29 together, side seal bag 180 comprises a web 182, first edge 184 defining an open mouth, edge fold 190, first side seal 192, and second side seal 194. Discrete panel section 191 (like discrete panel section 6) is installed on the individual bag, or on a slit bag tube that is then cut and sealed at predetermined intervals to make a series of side seal bags 180, by any suitable process such as any of those disclosed herein.

A bag can be made by extruding a thermoplastic tube to make a bag tubing; slitting the tubing at one longitudinal edge thereof to make a slit bag tubing; anchoring the discrete panel section as described herein to the slit bag tubing; and transversely cutting and sealing the bag tubing at predetermined intervals to make a plurality of individual bags each with the discrete panel section disposed thereon. The discrete panel section can function as described herein for other embodiments and processes, in providing an easy-open package. Some of the steps set out in US 2008/0138478 A1, for making a bag, are optional with respect to the present invention; such steps including irradiation and orientation of the tubing.

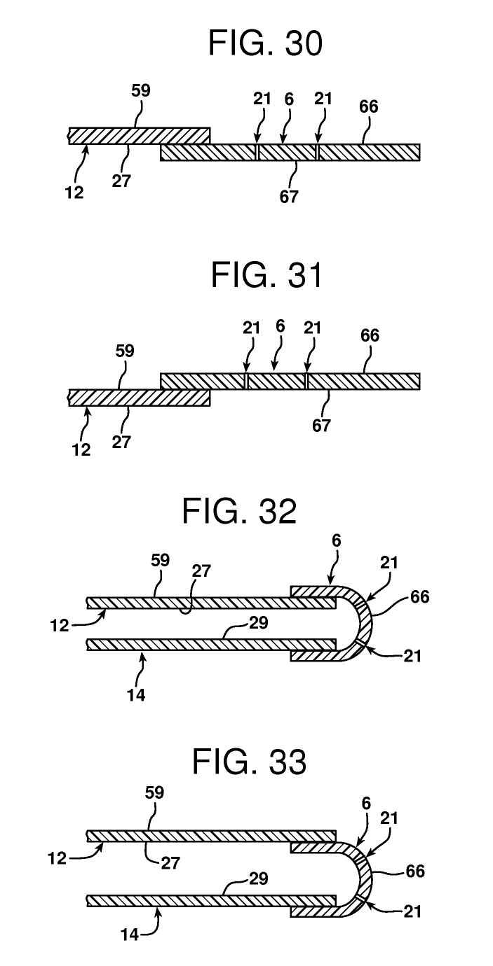

The discrete panel section can be anchored to the first side panel of a web, pouch, or package in a number of different configurations. An example is that shown in FIGS. 2, 2A, 3, and 30. FIG. 30 shows the discrete panel section 6 anchored to the first side panel 12 by anchoring a second portion of the outer surface 66 of the discrete panel section 6 to the inner surface 27 of first side panel 12.

FIG. 31 shows the discrete panel section anchored to the first side panel 12 by anchoring a second portion of the inner surface 67 of the discrete panel section 6 to the outer surface 59 of first side panel 12.

In other alternatives:
the second end of the discrete panel section is anchored to the first side panel 12 by anchoring a second part of the inner surface 67 of discrete panel section 6 to the outer surface 59 of first side panel 12, and the first end of the discrete panel section is anchored to the second side panel 14 by anchoring a first part of the inner surface 67 of discrete panel section 6 to the outer surface of second side panel 14. Panel section 6 in this embodiment thus wraps around the first ends of each of first side panel 12 and second side panel 14 (see FIG. 32).
the second end of the discrete panel section is anchored to the first side panel 12 by anchoring a second part of the outer surface 66 of discrete panel section 6 to the inner surface 27 of first side panel 12, and the first end of the discrete panel section is anchored to the second side panel 14 by anchoring a first part of the inner surface 67 of discrete panel section 6 to the outer surface of second side panel 14 (see FIG. 33).

For each of these alternatives, in the event that the anchor is in the form of a seal, appropriate sealants should be present at surfaces to be anchored by sealing.

Method of Operation

In opening the package of FIGS. 24A to 24C, die-cut segment 56 defined by a first closed-loop die cut 21 (see also FIGS. 26A to 26F) is manually grasped and pulled from the first side panel. The end of the panel section exposed by the removal of die-cut segment 56 is then grasped and pulled away from the second side panel 14, breaking through the easy-open seal to access product in the interior 57 of the package. During this opening sequence, the anchor in region “A” between surface 66 and surface 27 of first side panel 12 will typically remain intact, such that a portion of the panel section stays on and in contact with surface 27. More than one die cut can be present. The die cut is in some embodiments close-looped, i.e. the die cut defines a die-cut segment that can be displaced or completely removed from the first side panel of the package. A second die cut can also be close-looped, or can be open-looped and hinged such that the flap formed by a second die cut and a hinge line can be opened without removing the flap from the first side panel of the package. Alternatively, a single die cut can be used, that is either close-looped (FIGS. 25A, 26B, 26E, 26F) or includes a hinge line (FIGS. 25C and 25D; 26A and 26C). Each die cut can be of any suitable geometry and depth.

In opening the package of FIGS. 25A and 25B, the die-cut segment defined by a first closed-loop die cut 21 is likewise manually grasped and pulled from the first side panel. The end of panel section 6 exposed by removal of the die-cut segment is then grasped and pulled away from the second side panel 14, breaking through the easy-open seal to access product in the interior 57 of the package.

FIGS. 25C and 25D show in plan view another package opening sequence. An open-loop die cut is pulled away from the panel section to form a flap 26. The contents of the package can be accessed by pulling up the panel section to break through easy-open seal 38.

Method Of Making A Die Cut In A Web

A conventional die cutter can be used to create a first die cut 21, and optionally one or more additional die cuts 36 in a web that is used to make discrete panel section 6. Die cuts can be made by any suitable conventional process and equipment. Any suitable pattern of die cut can be used, open or close-looped, as long as it serves the function of providing an easy open package in which the packaged product can be accessed by means of a flap created at least in part by the die cut. Alternative patterns include elliptical, oval, triangular, three side rectangle, hour glass, “dog bone”, and other regular and irregular shapes.

The die cut extends completely through the discrete panel section, or may extend through most of, but not entirely through, the thickness of the discrete panel section. The die cut may extend through e.g. at least 50% of the thickness of discrete panel section 6, e.g. at least 60%, at least 70%, at least 80%, at least 90%, at least 95%, or 100% of the thickness of the discrete panel section. A single die cut can have a first portion that extends completely through the discrete panel section (a through-cut), and a second portion that extends partly through the discrete panel section (a score).

A laser system can be configured to produce a laser cut that cuts partly or completely through the discrete panel section, or alternatively, a die cut can be made using a mechanical cutting system using rotary engraved dies, or steel rule dies supported in platens as used in reciprocating presses. The choice of die cutting technique depends on several factors, including the thickness and physical nature of the film or web to be cut.

The die cut may sometimes act as a tamper evident feature.

The die cutting of a web used to produce a discrete panel section, and the assembling of a package incorporating the die-cut discrete panel section and a web, can be done at a single location, but more practically will typically be done at one or more separate locations, with the assembling of the package by a packager using a pre-provided die-cut discrete panel section prepared elsewhere and provided in advance of the packaging process.

The discrete panel section can thus be die-cut in advance of the packaging process.

Method of Application of the Discrete Panel Section to a Web

The panel section can be applied to a web by any suitable method. For example, the supplier of the web and/or panel section, or a converter can
1) advance a web by suitable motive means, such as a motor, from a first roll;
2) advance panel section 6 from a second roll; and
3) bringing the web and panel section 6 together at a pair of nip rolls such that the web is attached to the panel section, e.g. by heat-sealing or adhesive.

Alternatively, the panel section is anchored to the web as disclosed herein at the package facility where it will be used to make packages. This can be done as described herein by feeding the panel section into the packaging process, e.g. from an in-feed roll, to be anchored to the web or webs used to make the package.

Where two webs are used in conjunction with a discrete panel section, a combination of the above alternatives can be used.

The above descriptions are those of embodiments of the invention. All parts and percentages are by weight, unless otherwise indicated or well understood in the art. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. All references to ASTM tests are to the most recent, currently approved, and published version of the ASTM test identified, as of the priority filing date of this application. Each such published ASTM test method is incorporated herein in its entirety by reference.

Terms referring to polymers, such as polyester, polyamide, and polyolefin, refer herein to both homopolymers and copolymers thereof, unless otherwise specified.

With reference to the drawings, the flow of materials is in the direction of the arrows.

Those of skill in the art will recognize that the drawings herein are not necessarily to scale, and certain features of the invention may be graphically exaggerated for clarity.

Both the web or webs used in the manufacture of the package according to the invention, and the discrete panel section of the invention, can be made by any suitable process, including coextrusion, extrusion coating, extrusion lamination, and conventional lamination using polyurethane or other adhesives. These manufacturing processes are well known in the art. Extrusion can be done in annular or flat dies. The extrudate can be hot blown or cast, and optionally solid-state oriented as desired. Chemical or electronic crosslinking of one or more layers of the webs or the panel section can be done. Both web and discrete panel section can be advanced by suitable motive means (not shown, and well known in the art, such as a motor) from their respective rolls.

A package according to the invention can optionally carry printed indicia, which can be decorative or informational in nature. Decorative printed indicia can include a logo, a trademark, product information, etc. with text and/or graphics.

Printed indicia can be in the form of a message e.g. “easy open” or “open here”. This can be printed in scattered process (i.e. registration is not required) on or near the first end of the package. The message is surface printed or reverse printed.

The present invention, including the package and methods as disclosed herein, is provided in several embodiments in the absence of: plastic zipper closures; press-to-close or slide zippers; interlocking closures; reclosable fasteners with interlockable fastener elements; interlocking rib and groove elements having male and female profiles; interlocking alternating hook-shaped closure members, and the like. None of these aforementioned closures, zippers, elements, etc. is present in the package of the invention.

The package of the invention is provided herein in several embodiments in the absence of a PSA layer or coating between the discrete panel section and a base strip.

Although the invention is described in some embodiments herein as a package comprising a thermoplastic pouch comprising a first and second side panel each having a first end, a first side edge, and a second side edge, those skilled in the art will understand, after a review of this disclosure, that in some embodiments, wherein a single web is used, terms such as “second end”, and the like are used for convenience to describe the relative locations or regions on a single web made into a pouch, so that the overall geometry of the package, and relative positions of the various features of the invention can be described. Although the first and second side panels are shown in various embodiments as having the same length, the second side panel can be longer than the first side panel, i.e. extend beyond the first end of the first side panel. The extended portion can accommodate a hang tab with a hole therein.

In some embodiments, a seal can be applied obliquely across the two corners of the discrete panel section of a package of the invention, closest to the first end of the package, such that it crosses over and seals two corners of the discrete panel section to the second side panel. These angled seals can be useful in assuring the integrity of the package before initial opening. The angled seal can overlap a portion of the die cut 21 at upper edges of the die cut. Optionally, the die cut can be discontinuous in the regions of the die cut where the angled seals are present.

What is claimed is:

1. An easy-open package comprising:
a) a pouch comprising
i) a first and second side panel each comprising an outer and inner surface, a first and second side edge, and a first and second end, the first and second side panels joined together along their respective first and second side edges with a seal;
ii) a first end;
iii) a second end defined by the second ends of the first and second side panels respectively; and
iv) a discrete panel section comprising an outer and inner surface, a first and second side edge, and a first and second end, at least a portion of the inner surface comprising a sealant, wherein
the discrete panel section and the second side panel are joined together along at least a portion of their respective first and second side edges with a seal,
the first end of the discrete panel section is joined to the second side panel, and
a die cut is disposed in the discrete panel section; and
wherein the discrete panel section is anchored to the first side panel; and
b) a product disposed in the pouch.

2. The easy-open package of claim 1 wherein the discrete panel section is compositionally different from the first side panel.

3. The easy-open package of claim 1 wherein the inner surface of the discrete panel section comprises an easy-open sealant.

4. The easy-open package of claim 1 wherein a first portion of the die cut is a through-cut, and a second portion of the die cut is a score.

5. The easy-open package of claim 1 wherein the outer surface of the discrete panel section comprises a sealant.

6. The package of claim 1 wherein a second part of the outer surface of the discrete panel section is anchored to the inner surface of the first side panel.

7. The package of claim 1 wherein a second part of the inner surface of the discrete panel section is anchored to the outer surface of the first side panel.

8. The package of claim 1 wherein the first end of the discrete panel section, and the first end of the second side panel, are joined together with a seal.

9. The package of claim 1 wherein the first end of the discrete panel section, and the first end of the second side panel, are joined together with an easy-open seal.

10. The package of claim 1 wherein the second end of the first side panel, and the second end of the second side panel, are joined together with a seal.

11. The package of claim 1 wherein the second end of the first side panel, and the second end of the second side panel, are joined together with a fold.

12. The package of claim 1 wherein the die cut is a closed loop.

13. The package of claim 1 wherein the package is absent any zipper.

14. The package of claim 1 wherein the package is absent a repositionable adhesive between a base strip and the discrete panel section.

15. The package of claim 1 wherein the package can be opened with a peel force of from 25 grams/inch to 5 pounds/inch.

16. A method of making an easy-open package in a horizontal form/fill/seal process comprising:
a) providing a lay-flat web comprising a first and second surface;
b) providing a discrete panel section comprising an outer and inner surface, a first and second side edge, and a first and second end, at least a portion of the inner surface comprising a sealant, and a die cut disposed in the discrete panel section;
c) advancing the lay-flat web to a forming device to convert the lay-flat web to a folded web;
d) advancing the discrete panel section such that when the package is made, the discrete panel section is part of the package;
e) making side seals in the folded web and the discrete panel section;
f) cutting the folded web and the discrete panel section to produce an open pouch comprising a first and second side panel each comprising an outer and inner surface, a first and second side edge, and a first and second end, the first and second side panels joined together along their respective first and second side edges by a seal, the discrete panel section and second side panel joined along at least a portion of their respective first and second side edges by a seal, and the first end of the discrete panel section joined to the second side panel;
g) putting a product in the open pouch; and
h) sealing a first end of the pouch to close the pouch;
wherein, at any time before or during putting a product in the open pouch, the discrete panel section is anchored to the lay-flat web, the folded web, or the first side panel.

17. The method of claim 16 wherein the discrete panel section is compositionally different from the first side panel.

18. The method of claim 16 wherein the first end of the discrete panel section, and the first end of the second side panel, are joined together with a seal.

19. The method of claim 16 wherein the second end of the first side panel, and the second end of the second side panel, are joined together with a seal.

20. The method of claim 16 wherein the package can be opened with a peel force of from 25 grams/inch to 5 pounds/inch.
